(19) United States
(12) Patent Application Publication
(10) Pub. No.: US 2015/0098691 A1
(43) Pub. Date: Apr. 9, 2015

(54) TECHNOLOGY FOR DYNAMICALLY ADJUSTING VIDEO PLAYBACK SPEED

(71) Applicants: Daniel Avrahami, Seattle, WA (US); Eeva Ilama, Campbell, CA (US)

(72) Inventors: Daniel Avrahami, Seattle, WA (US); Eeva Ilama, Campbell, CA (US)

(21) Appl. No.: 14/128,094

(22) PCT Filed: Oct. 4, 2013
(86) PCT No.: PCT/US2013/063506

§ 371 Date: Dec. 20, 2013

(51) Int. Cl. H04N 5/783; H04N 5/85; H04N 9/82; G11B 27/10; G11B 27/30; H04N 9/87

(52) U.S. Cl. CPC H04N 5/783; G11B 27/3036; H04N 9/87; H04N 9/8205; G11B 27/105; H04N 5/85
USPC 386/241

(57) ABSTRACT

Technology for enhancing video playback is described. In some embodiments, the technology parses recorded event data into a plurality of segments. Data within each segment may then be analyzed in an attempt to identify the occurrence of potentially interesting events. Based on the analysis, a significance value is assigned to or adjusted for each segment. Based on the comparison of the significance value for a segment with one or more significance thresholds, a playback speed is assigned to the segment. A playback index correlating each segment with the assigned playback speed may then he produced and used to control playback speed during video viewing. This may allow relatively uninteresting portions of video to he automatically bypassed at high playback speed, while interesting portions are played at relatively low speed.

### BACKGROUND

Interest is growing in the use of personal electronic devices to record events such as birthday parties, sporting events, outdoor activities, and the like. In many instances users produce long video clips that include relatively few interesting events. For example a user may record a three hour bicycle ride through the mountains, of which only a few minutes may be considered interesting. When reviewing the video, the user may have to watch large amounts of uninteresting video before an interesting portion of the video is reached. Although the user may manually fast forward through the uninteresting portions, this may result in the user missing interesting portions of the video unless the fast forward playback speed is reduced.

In part to address this issue, technology has been developed to edit recorded video data to identify key frames (instances), and to index those key frames. The key frames provide a convenient basis for a user or viewer to navigate quickly through a video by skipping from key frame to key frame. However, identifying these key frames automatically can be difficult and, if performed manually, is a laborious process for the user.

Technology for automatically identifying key frames and producing key frame indexes has also been developed. Such technology may rely on changes in video, audio, and/or other sensor data produced while an event is recorded by a device. Although those technologies can eliminate much of the labor associated with the manual assignment of key frames, they may still provide an insufficient user experience. For example, an automatic key frame identification system may miss events in a recording that may be considered interesting to a user. This may undermine user confidence in the system's ability to identify all interesting events in a recording. Automatic key frame identification systems may also erroneously assign key frames to portions of a recording that are not interesting to the user. In such instances it may be necessary for the user to expend significant time and effort removing unwanted key frames.

Accordingly, there remains a need in the art for improved techniques for reviewing and/or editing recordings, and in particular for reviewing video recordings.

### BRIEF DESCRIPTION OF THE DRAWINGS

FIG. 1 illustrates a block diagram for an exemplary system consistent with the present disclosure.

FIG. 2 illustrates another exemplary system consistent with the present disclosure.

FIG. 3 illustrates another exemplary system consistent with the present disclosure.

FIG. 4 illustrates another exemplary system consistent with the present disclosure.

FIGS. 5A-5C illustrate additional exemplary systems consistent with the present disclosure.

FIG. 6 depicts an exemplary use case consistent with the present disclosure.

FIG. 7 depicts an exemplary method of generating a playback index consistent with the present disclosure.

FIG. 8 depicts a method for altering the manner in which a playback index is generated, consistent with the present disclosure.

### DETAILED DESCRIPTION

Various embodiments of the present disclosure are directed to enhancing the viewing of videos. The term “video” as used herein generally refers to a medium that when executed presents a sequence of images that depict motion. A video may include a digital recording that contains a video track, and may optionally include or be associated with other recorded data, such as an audio track or other sensor data. Consistent with various embodiments, the technology described herein may enhance the viewing of a video by parsing a video into a plurality of segments. Once the video is parsed, the technology described herein may utilize the video and/or other sensor data collected in conjunction with a video to assign significance value to each segment of the video. The significance value of each segment may then be compared to one or more significance thresholds, wherein each threshold is associated with a corresponding playback speed. For example, significance values above a first significance threshold may be associated with a first (e.g., relatively slow) playback speed, while significance values below the first significance threshold may be associated with a second (e.g., relatively fast) playback speed.

In this manner, the technology described herein may produce an index. (playback index) for a video, wherein the playback index provides a playback speed for each segment of the video. As used herein, the term “segment” generally refers to a temporal subsection of a video. For example, the technology described herein may parse a video into Y/n segments, wherein Y is the total length of the video (e.g., in seconds) and it is the length of each segment (e.g., also in seconds), which may be set automatically or by a user. Thus for example if a video is 30 minutes long (Y=1800 s) and the segment length 5 seconds (n=5 s), the video may be parsed into 360, 5 second long segments. Such values are of course exemplary, and any video length and segment length may be used. For example, video may be parsed into segments ranging from about 0.1 milliseconds to about 1000 milliseconds (ms) or more, such as about 200 ms, about 400 ms. about 600 ms, or even about 800 ms. Alternatively or additionally, each segment may correspond to about 1, 2, 5, 10, 20, 30. 40, 50, 60 or more frames of a video. It should also be understood that the length of each segment need not be the same. For example, segment length may be increased or decreased depending on the significance values assigned by the system, a user input, and combinations thereof.

In still other embodiments, the technology described herein may analyze all or a portion of recorded event data, and assign significance values to portions that are determined to be significant or otherwise of potential interest to at user. In other words, recorded event data may be analyzed as a whole for data signifying potentially interesting events. Subsequently, the recorded event data may be parsed into segments, e.g., based on the degree to which the technology determines that such segments are interesting or uninteresting. The technology described herein may in some embodiments make such assignments based on significance values assigned to relatively interesting and relatively uninteresting portions of the recorded event data.

The term “significance value” is used herein to refer to a value that is assigned by the technology described herein to a segment of video. In general a significance value assigned to a segment may represent the degree to which the content of the segment may be considered interesting to a viewer of the video in question. In some embodiments, significance values for each frame may he set based on an analysis of video data and/or sensor data that is temporally mapped to the video data. The manner in which significance values are determined by the technology described herein may be impacted by control parameters in a control profile, as described later.

As detailed below, consistent with various embodiments sensor data may be collected by a sensor that is co-located with a video recording device in the same apparatus, such as a video camera. In other embodiments sensor data may be collected by a sensor that is housed in a separate apparatus from that containing the video recording device. Accordingly, the term “sensor data” is used herein to refer to data recorded from one or more sensors or sensor components, such as an audio sensor, global positioning sensor, biometric sensor, another sensor or sensor component described herein, combinations thereof, and the like.

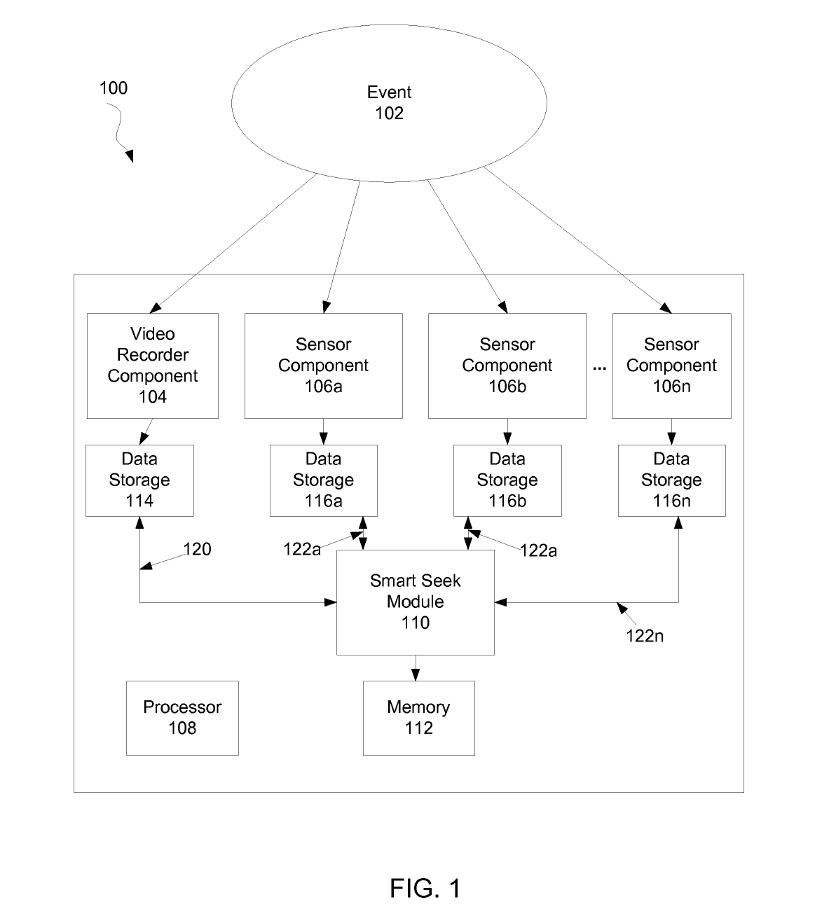

FIG. 1 illustrates a block diagram for a video review system 100 consistent with the present disclosure. In general, video review system 100 is directed to processing video and other data to enhance the viewing of a video by assigning playback speeds to various portions of the video under consideration. The video review system 100 may organize multiple types of data including video, where the multiple types of data are recorded at a common event, such as event 102. In various embodiments, in addition to video data, other types of recording devices such as sensors may collect data that can be temporally correlated to a recorded video track for use in identifying portions of the video track that may facilitate editing of the video. For convenience, video and/or sensor data recorded from an event may be individually or collectively referred to herein as “recorded event data.” In some embodiments, recorded event data includes video data and sensor data that is temporally mapped to the video data.

Various functions provided by video review system 100 are illustrated in FIG. 1 alongside various components that may perform those functions. As illustrated, video review system 100 supports the recording of video and sensor data, the storage of the recorded data, transfer of data for processing, and the production of a playback index for the video based on at least one of the video and sensor data.

As shown in FIG. 1, video review system 100 includes video recording component 104 that may collect and/store video data from the event 102. Examples of video recording component 104 include a dedicated video camera, a digital camera having video recording capability, a mobile telephone, smart phone, tablet computer, notebook computer, or other computing device having video recording capability. Of course, other types of video recording components may be used, and are contemplated by the present disclosure.

Video review system 100 further includes sensor components 106a, 106b, to 106n, wherein at least one of a, b, and n are a positive integer and the number of sensor components in the set is greater than zero. Non-limiting examples of sensor components include an accelerometer, an audio sensor (e.g., a microphone) a biometric sensor, a global positioning system (GPS) sensor, a gyrometer, a pressure sensor, a temperature sensor, a light sensor, a humidity sensor. Exemplary biometric sensors include an optical or infrared camera, iris scanner, facial recognition system, voice recognition system, finger/thumbprint device, eye scanner, biosignal scanner (e.g., electrocardiogram, electroencephalogram, etc.), DNA analyzer, gait analyzer, microphone, combinations thereof, and the like. Such biometric sensors may be configured to identify and/or record information regarding the biosignals (brain waves, cardiac signals, etc.), ear shape, eyes (e.g., iris, retina), deoxyribonucleic acid (DNA), face, finger/thumb prints, gait, hand geometry, handwriting, keystroke (i.e., typing patterns or characteristics), odor, skin texture, thermography, vascular patterns (e.g., finger, palm and/or eye vein patterns), and voice of a human or other animal, combinations thereof, and the like.

In various embodiments, all or a portion of the components of video review system 100 may be co-located in a common apparatus or may be located in different apparatus that are linked via one or more wired and/or wireless communication links. When implemented as a set of components that are coupled through wired communication links, for example, video review system 100 may include one or more elements arranged to communicate information over wired communications media such as a wire, cable, printed circuit hoard (PCB), backplane, switch fabric, semiconductor material, twisted-pair wire, co-axial cable, fiber optics, combinations thereof, and the like. The wired communications media may he connected to video review system 100 using an input/output (I/O) adapter (not shown), which may he arranged to operate with any suitable technique for controlling information signals between elements using a desired set of communications protocols, services or operating procedures. The I/O adapter may also include the appropriate physical connectors to connect the I/O adapter with a corresponding communications medium. Exemplary I/O adapters include but are not limited to a network interface, a network interface card (MC), a disc controller, a video controller, an audio controller, combinations thereof, and the like.

When implemented as a set of components that are coupled through wireless communication links, for example, video review system 100 may include wireless elements arranged to communicate information over wireless communication media. Exemplary wireless communication media include but are not limited to portions of a wireless spectrum, such as the radio frequency (RF) spectrum. The wireless elements may also include components and interfaces suitable far communicating information signals over the designated wireless spectrum, such as one or more antennas, wireless transmitters, receiver, transmitters/receivers (“transceivers”), amplifiers, filters, control logic, antennas, combinations thereof and the like.

In the embodiment of FIG. 1, video review system 100 includes processor 108, memory 112, and smart seek module 110 whose operation will he detailed below. Generally, smart seek module 110 is operable to couple at least temporarily to video recording component 104 and sensor component(s) 106a-106n. In various embodiments and as shown in FIG. 1, video recording component 104 and/or sensor components 106a-106n may store data collected as video data and/or other sensor data. Such data may be subsequently transferred for processing by smart seek module 110. For example, video data from the event 102 may be collected and stored by a video camera in data storage 114, while sensor component 106a collects and stores motion data from the event 102 in data storage 116a. Both sets of data can then he transferred to smart seek module 110 for processing.

Data storage 114 and data storage 116a-n may be any convenient storage medium/device. For example, data storages 114, 116a-116n may include a disk drive, a hard drive, an optical disc drive, a universal serial bus (USB) flash drive, a memory card, a secure digital (SD) memory card, a mass storage device, a flash drive, a computer, a gaining console, a compact disc (CD) player, computer-readable or machine-readable memory, a wearable computer, a portable media players (PMP), portable media recorders (PMR), a digital audio device (e.g., MP3 player), a digital media server, combinations thereof, and the like. Of course., other types of data storage may be used as data storages 114 and 116a-116n, and it should he understood that the types of data storage used for such elements need not be the same.

In cases where video recording component 104 or sensor component 106a-106n is not initially linked to the respective data storages 114, 116a-116n, a user may manually connect the video recording component 104 or sensor component 106a-106n to the respective data storage. For example, data storages 114, 116a-116n may form part of the respective video recording component 104, or sensor component 106a-106n. In such cases, to process video data collected from the event 102, a user may manually couple video recording component 104/sensor component 106a-106n to a device that contains smart seek module 110. As shown in FIG. 1, coupling of data storage 114 may take place over link 120, whereas data storages 116a to 116n may be coupled to smart seek module. 110 via links 122a to 122n, respectively. In various embodiments, links 120 and 122a to 122n may he any combination of wired or wireless links, and may be reversible or permanent links. Although links 120 and 122a to 122n are depicted as directly connecting smart seek module 110 to the respective data storages 114 and 116a to 116n, such data storages may instead be coupled to memory (not shown) in a device housing the smart seek module 110.

Therefore in the embodiment of FIG. 1, video data and sensor data (not separately shown) may be collected from an event 102 by the video recorder component 104 and sensor component(s) 106a-106n, and optionally stored in data storages 114 and/or 116a-116n. The video and sensor data may then he transferred for processing by smart seek module 110. Transfer of such data may he directly to smart seek module 110 and/or to a memory such as memory 112. Sensor data recorded from event 102 may be temporally mapped to video data recorded from event 102, either before or after transfer of such data to smart seek module 110. For example, sensor and video data recorded from event 102 may he processed by processor 108 and/or another module in system 100 to temporally map the sensor data to the video data prior to transferring the mapped data (e,g., recorded event data) to smart seek module 110. Alternatively, smart seek module 110 may be configured to temporally map sensor data recorded from event 102 to corresponding video data.

In some embodiments, video data may he collected by video recorder component 104 as a video stream (video track) that is processed by smart seek module 110 for another module) to temporally align frames of the video data with corresponding portions of sensor data collected by sensor component(s) 106a-106n. The smart seek module 100 may therefore generate time stamps or other indicia that map portions of the sensor data to instances or frames of the video data hi this manner, one or more portions of the sensor data may he temporally correlated with a corresponding data frame of the video data recorded by video recorder component 104.

Processor 108 may be employed by smart seek module 110 to execute processing operations or logic to perform operations such as video parsing, significance value assignment, playback index generation and combinations thereof. Any suitable processor may he used as processor 108, including but not limited to general purpose processors and application specific integrated circuits. Such processors may he capable of executing one or multiple threads on one or multiple processor cores. The type and nature of processor 108 may he selected based on numerous factors such a device form factor, desired power consumption, desired processing capability, combinations thereof, and the like. Non-limiting examples of suitable processors that may be used as processor 108 include the mobile and desktop processors commercially available from INTEL®, Advanced Micro Devices (AMD®), Apple®, Samsung®, and Nvidia®. Without limitation, processor 108 is preferably an INTEL® mobile or desktop processor or an application specific integrated circuit.

Video review system 100 may he configured to perform various operations, such as but not limited to video and sensor data collection operations, mapping operations, video parsing operations, significance value assignment operations, playback index generation operations, video playback operations, combinations thereof, and the like. In some embodiments, video review system 100 may produce a playback index specifying a playback speed for segments of a video. Moreover, video review system 100 may be configured to replay the video in question at the playback speeds specified in the playback index. Accordingly, video review system may play interesting portions of video at a first (relatively slow) speed (e.g., 0.1×, 0.5×, 1×, 2×, 4×, etc., where X is the real time playback speed of the video) and to play potentially uninteresting portions of video at a second (relatively high) speed (e.g. 16×, 32×, 64×, 96×, 128×, etc.).

More generally, video review system 100 may automatically fast forward through uninteresting portions of a video, reduce playback speed during interesting portions of video, and automatically resume fast forwarding once the interesting portions of the video are over. This may present a better user experience while viewing long videos, particularly long videos that include relatively few interesting moments embedded in otherwise large amounts of uninteresting video. In any case, a playback index produced by video review system 100 may be stored in a memory, such as memory 112.

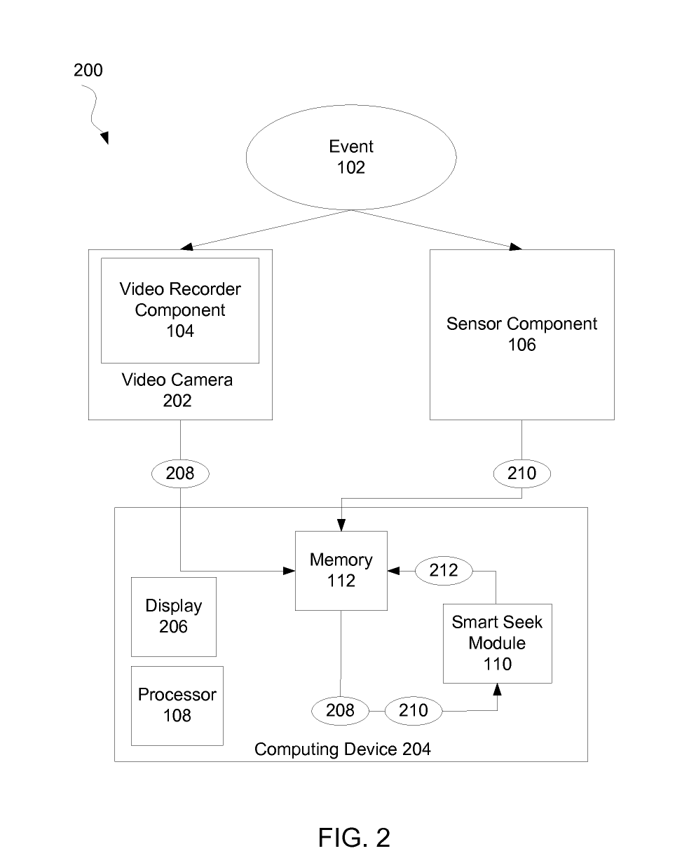

FIG. 2 illustrates a block diagram for another video review system consistent with the present disclosure. In this example video review system 200 includes multiple apparatus, in which one apparatus houses video recorder component 104 and another houses sensor component 106. For the sake of illustration in this and other examples, a single sensor component 106 is depicted (without a separate housing shown), which may represent one or more sensor components 106a-106n unless otherwise noted.

In the arrangement of FIG. 2, video camera 202 and sensor component. 106 may be independently deployed to record event 102. For example, video data of event 102 may be recorded by video camera 202 while sensor component 106 is independently positioned to record sensor data from event 102. Video data and sensor data may thus be independently collected at the same time to capture event 102. For example, video camera 202 may record video that objects in motion, while a motion sensor device (which may include an accelerometer and/or gyrometer components) or set of sensor devices is deployed on or within one or more of the objects recorded by video camera 202 so as to record sensor (e.g., motion) data from such objects. Alternatively or additionally, sensor component 106 may include, an audio sensor, GPS sensor, biometric, sensor, and/or another type of sensor, which may record corresponding sensor data types from event 102 independently or in conjunction with the video data recorded by video camera 202 and/or other sensors in video review system 200.

As further illustrated in FIG. 2, video review system 200 includes a computing device 204. Computing device 204 may be any suitable computing device such as a mainframe computer, desktop computer, laptop computer, notebook computer, tablet computer, smart phone, cellular phone, personal data assistant, portable media player, combinations thereof, and the like. Computing device 204 may be arranged to receive recorded event data (including video data 208 and sensor data 210) from video camera 202 and sensor component 106, respectively. In this embodiment computing device 204 includes smart seek module 110, processor 108 and memory 112.

As generally discussed above, smart seek module 110 may parse recorded event data into a plurality of segments, and assign a significance value to each segment based on an analysis of at least one of video data 208 and sensor data 210. Smart seek module 110 may further assign a playback speed to each segment based at least on a comparison of the assigned significance value to at least one significance threshold. The assigned playback speed for each segment may then he recorded in a playback index for the recorded event data, either alone or in conjunction with a corresponding segment identifier (e.g., timestamp) in the playback index.

More specifically, smart seek module 110 may be configured to perform parsing operations on recorded event data not shown), which may include video data 208 and/or sensor data 210 temporally mapped to video data 208. Pursuant to such operations, smart seek module 110 (or another module) in some embodiments may determine a total length (Y) of the video data and/or recorded event data under consideration. Smart seek module 110 may then parse the recorded event data into a number of segments (S) by dividing Y by a segment length (n), such that S=Y/n. Segment length n may be any desired length, as discussed generally above.

Although the present disclosure envisions video review systems that parse recorded event data into a plurality of segments of equal length, the parsing of such data into temporally equal lengths is not required. For example, smart seek module 110 may he configured to parse a recorded event data into a plurality of first segments of a first length, and to further parse at least one of the first segments into a plurality of second segments of a second length, wherein the second length differs from the first length. Smart seek module 110 may then proceed to assign significance values for each of the first segments and second segments as discussed below. In some embodiments, the length and/or position of at least one of the first and second segments may be specified by smart seek module 110 in response to a user input.

Smart seek module 110 may he further configured to assign significance values to each segment of the parsed video data 208 and/or recorded event data In some embodiments, such significance, values may be determined based on an analysis of video data 208 and/or sensor data 210, as discussed below. In this regard, smart seek module 110 may analyze sensor data 210 within each segment to determine whether the content of the corresponding video data 208 may he considered interesting to a viewer.

In some embodiments, smart seek module may be configured to initially assign each segment of recorded event data a first significance value, e.g., 1.0. Smart seek module 110 may then adjust die first significance value of a segment upward or downward based on an analysis of the video and/or sensor data within that segment. The adjustment of the first significance value may in some embodiments be performed by a machine learning classifier within smart seek module 110, which may be used to analyze the video and/or sensor data within a segment and determine whether or not the segment contains something that may he interesting to a user and thus determine whether the first significiance value, of a segment should be increased or decreased.

While the present disclosure focuses on embodiments wherein a first significance value is an unaltered value assigned by a smart seek module, it should be understood that such embodiments are exemplary only and that the first significance value may correlate to some other value. For example, a first significance value may correlate to as previous significance value assigned and/or adjusted by as smart seek module, and which is being analyzed for adjustment, e.g., to account for new or additional video and/or sensor data. Therefore it should be understood that the term “first” in “first significance value” is merely used to designate a significance value that is being considered for alteration by as smart seek module.

In various embodiments, the first significance value assigned to a segment may be adjusted upward or downward based on the determined behavior of sensor data 210 within the segment. The first significance value may in some embodiments he a default significance value assigned to a segment. Alternatively or additionally, the first significance value may he a significance value previously assigned by the smart seek module to the segment, e.g., based on a prior analysis of video and/or other sensor data in the segment. In any case, smart seek module 110 may in some embodiments upwardly adjust the first significance value applied to a segment when a fractional and/or rate of change in Sensor (e.g., accelerometer, (GPS, velocity, force, etc.) data 210 in such segment exceeds a predetermined threshold (fractional change threshold). Likewise, smart seek module may downwardly adjust the first significance value applied to a segment if is fractional and/or rate change in sensor data 210 does not exceed the predetermined threshold, optionally for a predetermined amount of time. Regardless of the manner of adjustment, the resulting significance value may be referred to herein as an “adjusted” significance value.

Alternatively or additionally, smart seek modulo may adjust the first significance value of a segment upwards or downwards if it determined that a sign of sensor data 210 changes within a segment of recorded event data. That is, smart seek module 110 may increase or decrease the first significance value of a segment if sensor date within the segment changes from positive to negative, or vice versa.

For example, large changes in sensor values within a segment or between adjacent segments may he used to identify portions of video that may be of greater or lesser interest to a user. When a change in sensor data values in a segment exceeds a threshold (e.g., by a predetermined amount such as about 10, 20, 50, etc, percent), smart seek module 110 may correspondingly increase the first significance value assigned to the segment. The amount by which the first significance value is increased (or decreased) may be a predetermined amount, or it may correlate to the degree to which the sensor data exceeds the predetermined threshold. Thus for example, smart seek module may increase the first significance value by 10% when sensor data 210 exceeds the predetermined threshold by 10%, and by 50% if sensor data 210 exceeds the predetermined threshold by 50%.

When sensor data 210 includes positional data such as data from a global positioning system (GPS) smart seek module 110 may be configured to adjust the first significance value of a segment based on an analysis of the positional data in the segment. For example, smart seek module 110 may upwardly adjust the first significance value assigned to a segment if positional information in the segment signifies that sensor component 105 was in proximity to a location of interest, e.g., specified by as user or correlated to one or more predetermined landmarks. Smart seek module 110 may determine whether the first significance value should be adjusted upwards or downwards by comparing positional data within a segment to one or more distance thresholds. If positional data within a segment signifies that the distance of sensor 106 is more or less than a distance threshold from as location of interest, smart seek module 110 may respectively adjust the first significance threshold downwards or upwards.

First, second, third, etc. distance thresholds may also he specified, with the first distance threshold being closest to a location of interest and higher numbered thresholds being correspondingly further away. In such instances, smart seek module 110 may increase the magnitude of adjustment to the first significance value when the positional data indicates that sensor 106 is within a distance threshold that is closer to a location of interest. For example, if positional data within a first segment indicates that sensor 106 is within a first distance threshold (relatively close to a location of interest), smart seek module 110 may upwardly adjust the first significance value applied to the first segment by 50%. If positional data within a second segment indicates that sensor 106 is outside the first distance threshold but within a second distance threshold (further away from the location of interest), smart seek module 110 may upwardly adjust the default value applied to the second segment by 30%. Of course, such adjustment magnitudes are exemplary only, and any adjustment magnitude may be used.

Alternatively or additionally, smart seek module 110 may be configured to adjust the first significance value of a segment upwards by a predetermined amount (e.g., 1%, 10%, 20%, 30%, etc.) when positional data within the segment indicates that the location of sensor 106 is within a specified distance threshold. Moreover, smart seek module may be configured to leave the first significance value unchanged when positional data within a segment indicates that the location of sensor 106 is outside a distance threshold from a location of interest.

Still further, smart seek module 110 may he configured to assign to a segment a significance value that exceeds a significance threshold when positional data from sensor 106 indicates that it is within a predetermined distance threshold of a location 01 interest. In other words smart seek module 110 may automatically determine that segments of video taken proximate to a location of interest (which may be set, e.g., in response to a user input) would be interesting to a user, and assign a significance value reflective of such determination.

When sensor data 210 includes biometric information (e.g., when sensor component 106 includes at least one biometric sensor), smart seek module 110 may he further configured to adjust the first significance value assigned to a segment based on the presence or absence of biometric information within the segment. In this regard, smart seek module 110 may he configured to analyze each segment of recorded event data for biometric information. Depending on the presence or absence of such information, smart seek module may increase/decrease the first significance value of a segment, and/or leave the first significance value unchanged.

By way of example, the sensor components described herein may include one or more microphones which may record audio data from event 102. Such audio data may be temporally mapped to video data produced by video camera 202. The resulting recorded event data may he parsed into segments, by smart seek module 110, after which smart seek module may analyze the audio data in each segment for an audio signal having characteristics of interest, which may be specified in a biometric (or other) reference template or in some other manner. For example, smart seek module 110 may analyze segments of recorded event data for the audio information correlating to audio information in a reference template of a specific person, animal, object and/or location. If smart seek module 110 detects the presence of such audio data in a segment, it may increase/decrease/not change the first significance value applied to the segment. The degree of adjustment may in some embodiments depend on the confidence with which smart seek module 110 believes that the audio information is present. Likewise, smart seek module 110 may increase/decrease/not challenge the first significance value applied to a segment if biometric audio information of interest is not detected in the segment.

Alternatively or additionally, smart seek module 110 may be configured to assign to a segment a significance- value that exceeds a significance threshold when data from sensor 106 indicates that the segment includes audio (or other (e.g., biometric) information of interest. In other words, smart seek module 110 may automatically determine that segments of video that include- specified biometric information (which may be set, e.g., in response to a user input) would be interesting to a user, and assign a significance value reflective of such determination.

Of course, sensor component 106 is not limited to an audio sensor, and the type of biometric information that may be analyzed by smart seek module 110 is not limited to audio. Indeed, sensor component 106 may include one or more biometric sensors, such as those described above, which may produce and send biometric data to computing device 204. In such instances, smart seek module may analyze segments of recorded event data for the presence of biometric information contained in one or more biometric reference templates, and may adjust the first significance value of each segment in the same manner specified above with respect to audio information. That is, smart seek module 110 may increase/decrease/not change the first significance value of a segment of recorded event data when biometric information correlating to information in a biometric template is or is not detected.

The treatment of video data 208 and sensor data 210 from the time it is recorded to the time that a playback index is generated may differ according to different embodiments. In the example illustrated in FIG. 2, sensor data 210 and video data 208 may he stored in memory 112 of computing device 204, and subsequently retrieved by the smart seek module 110 for processing to generate playback index 212, which may then also be stored in the memory 112. However, embodiments are possible in which video data 208 and/or sensor data 210 are directly retrieved by computing device 204 from video camera 202 and/or sensor component 106 and processed by smart seek module 110 without first being stored in memory 110. For example, smart seek module 110 may be embedded in a video editing application or program that is configured to allow a user to retrieve and process a video track and sensor data from devices such as video cameras and sensor components that can be reversibly coupled to the computing device 204,

Therefore a user or group of users may collect video data 208 and sensor data 210 generated at an event 102 and transfer such data at their convenience to a computing device 204 for subsequent viewing of a video track. Before or at the time a video is to he viewed, smart seek module 110 may be launched, recorded event data (including sensor data 210 temporally mapped to video data 2081 may be processed, and a playback index 2.12 may be generated. The playback index may then be used to facilitate viewing/editing of the video as desired.

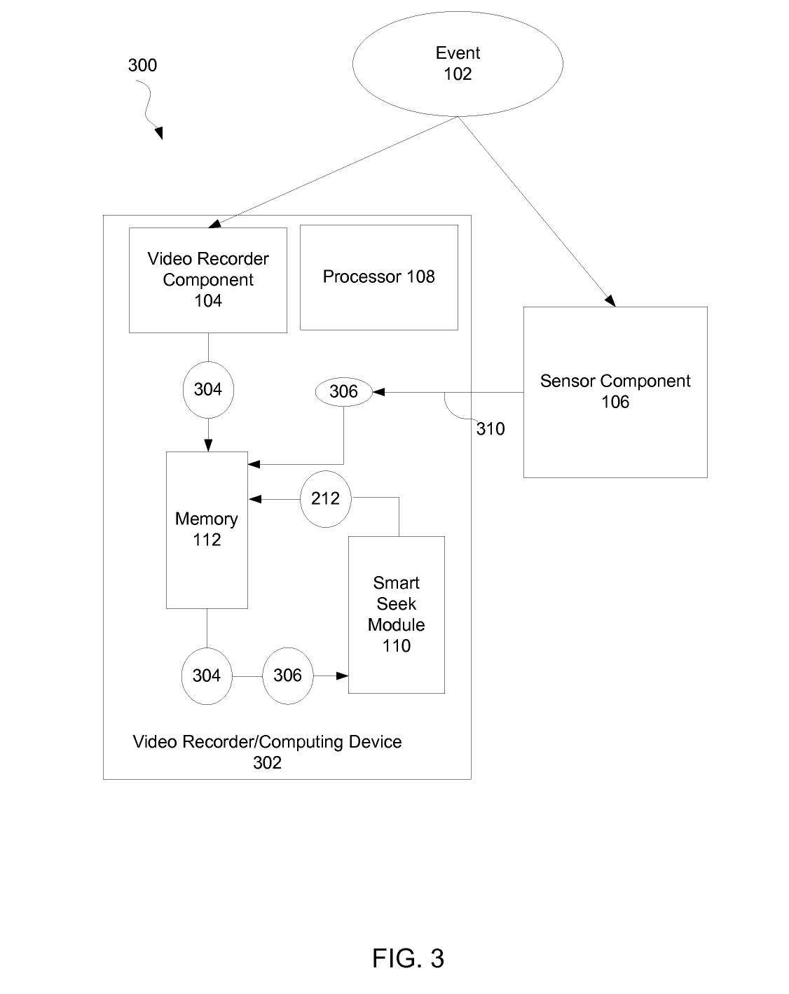

FIG. 3 illustrates a video review system 300 according to another embodiment. As illustrated, video review system 300 includes a video recorder component 104 that is housed in a separate apparatus than that of sensor component 106. In particular, video recorder component 104 is located in video recorder/computing device 302. Video recorder/computing device may be, for example, a portable device such as a tablet computer, notebook computer, smart phone, cellular phone, personal data assistant, ultra mobile personal computer, or another device that includes video playback capability. In this case video recorder/computing device 302 includes smart seek module 110, processor 108, and memory 112, that facilitate generating a playback index for a video that is recorded by the video recorder/comppling device, as discussed above.

In some embodiments a first user may employ the video camera/computing device. 302 to record video data 304 from event 102 while sensor data 306 from the event 102 is collected from a separate device sensor component 106, which may for example be located in a moving object at event 102. Video data 304 and sensor data 306 may both be stored within a memory 1.12 and used by smart seek module 110. In one example a user may record the video data 304 from the event 102 with video recorder/computing device 302, while a sensor component 106 records sensor data 306 separately. Sensor component 106 may be subsequently coupled to the video recorder/computing device 302 via link 310 to transfer sensor data 306 to video recorder/computing device 302. Link. 31.0 may be any convenient link, such as a wireless RF link, an infrared link, wired connection such as a serial connection including a universal serial bus connection, and so forth.

Once video data 304 and sensor data 306 are transferred to video recorder/computing device 302, such data may be stored in the memory 112 for use b the smart seek module 110. In particular, smart seek module 110 may retrieve video data 304 and sensor data 306, temporally map them (if they were not previously mapped), segment the recorded event data, perform significance value assignment, and generate a playback index as generally described above with respect to FIG, 2.

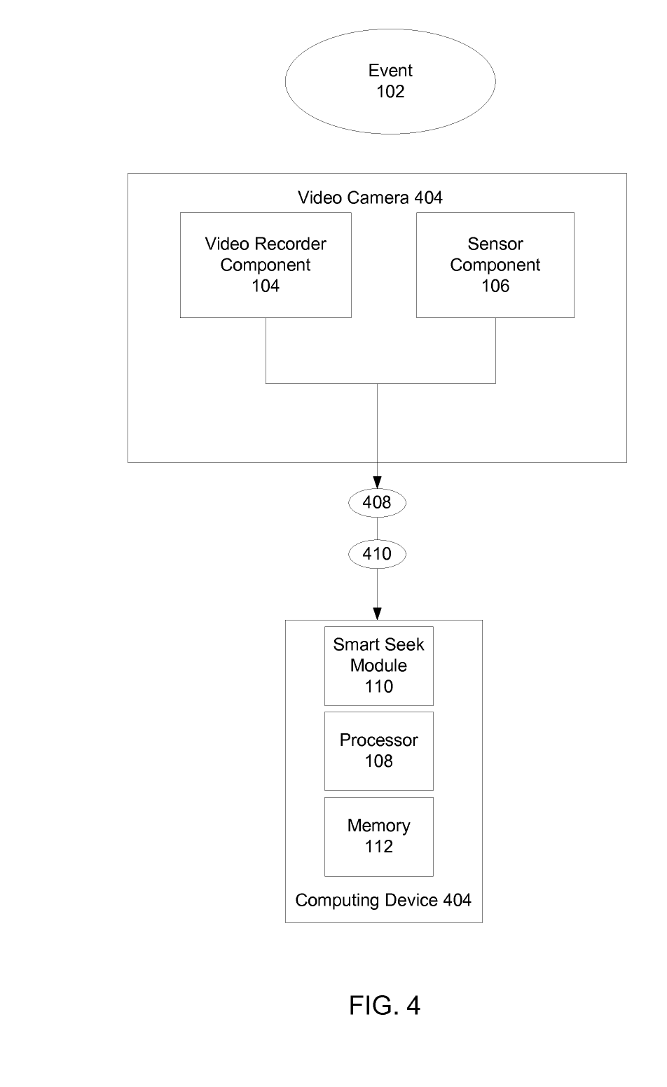

In other embodiments video data and sensor data may be recorded in a single apparatus for later processing to generate a playback index. FIG. 4 illustrates one embodiment of a video review system 400 in which a video camera 402 includes a video recorder component 104 and sensor component 106. In one instance sensor component I 06 may be an accelerometer or combination of accelerometer and gyrometer, such as those that are frequently deployed in present day mobile devices including cameras, smart phones, tablet computers, and the like. Therefore in some embodiments, sensor component 106 may he a component that detects motion in the video camera. In one example, if video camera 402 is deployed in an event in which video camera 402 undergoes motion while recording video, the motion of the video camera itself may be captured by sensor component 106. In one example, video data and sensor data are captured and stored by the video camera 402 in a memory of the video camera 402 (not shown).

The video and sensor data that is recorded from event 102 and stored in video camera 402 may subsequently be transferred to computing, device 404 for viewing the video, as illustrated in FIG. 4As shown, computing device 404 includes smart seek module 110, processor 108 and memory 112, which function as previously described. Computing device 404 may be, for example, any general purpose computer such as a desktop or laptop computer, notebook computer, tablet computer, hybrid computer/communications device, smart phone, cellular phone, or another device suitable for viewing content including video.

When a user has recorded and stored video data 408 and sensor data 410 in the video camera 402, the user may subsequently wish to view the video. The user may therefore couple video camera 402 to computing device 404 to transfer the video data and sensor data for analysis and viewing. Video camera 402 may he coupled to computing⁻ device 404 via link 406, which may be a wired and/or wireless connection. Video data 408 and sensor data 406 may then be transferred to the computing device 404 for playback index for the video recorded from event 102, as generally described above with respect to FIGS, 1-3,

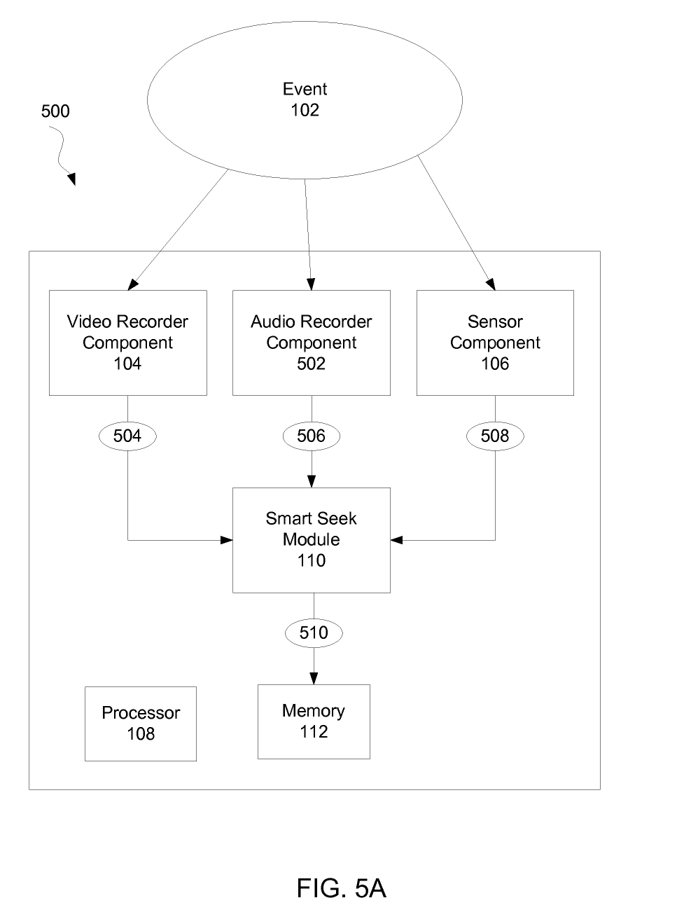

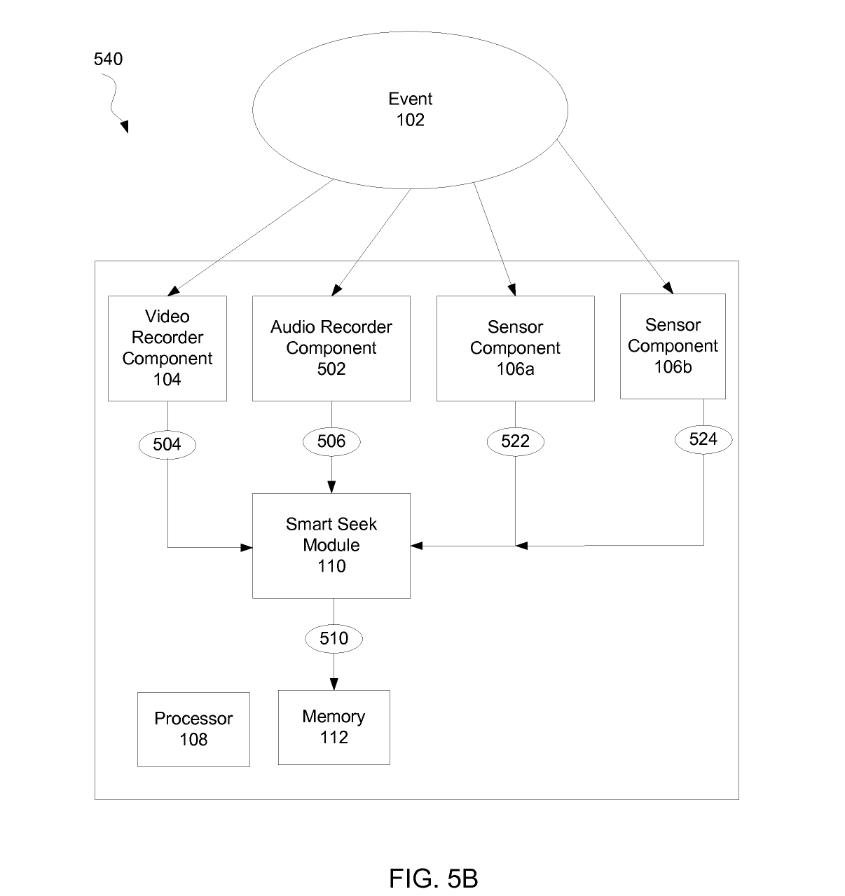

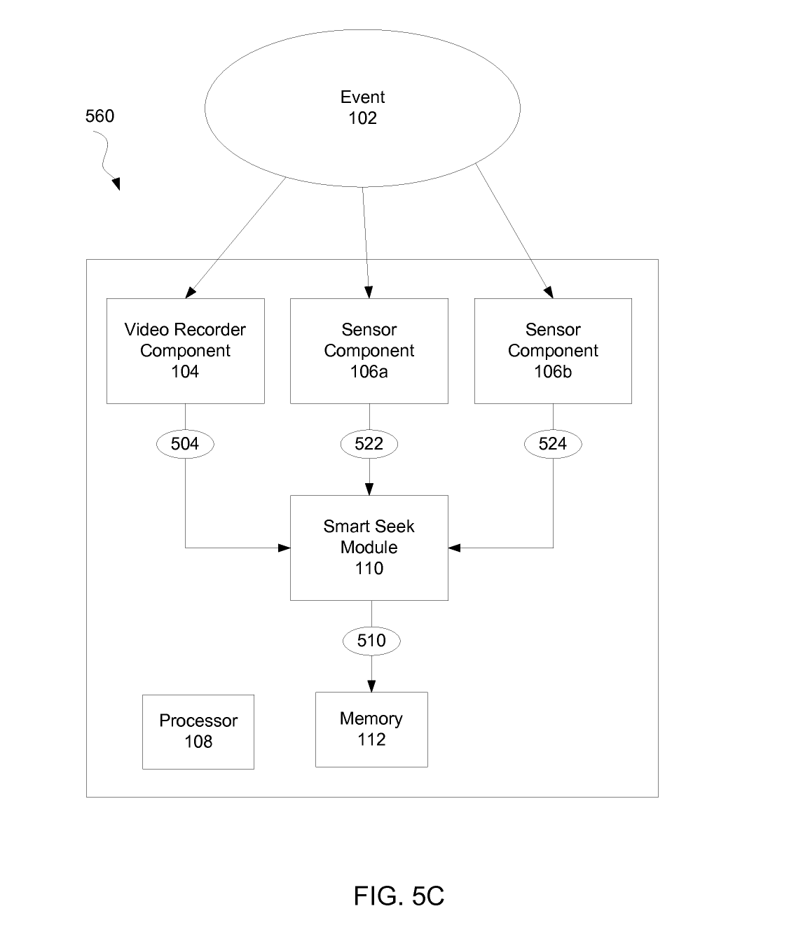

In further embodiments, video and sensor data recorded from an event may be combined with audio data in support of producing a playback index. FIG. 5A depicts one example of a video review system 500 including such features. As shown, video recorder component 104, sensor component 106, and audio recorder component 502 record video, sensor and audio data from event 102. Of course the illustrated embodiment is exemplary, and the video review system may be arranged in other ways, such as shown in FIGS. 1-4, for example.

Returning to FIG. 5A, video recorder component 104, sensor component 106, and audio recorder component 502 may record data from an event 102. For example, in one embodiment a video camera (not shown) of system 500 may house as microphone (audio recording component 502) and video recording component 104, which are used to record video and audio from the event. A separate sensor component 106 may record sensor (e.g. motion/position/biometric/etc.) data while the audio and video are being recorded by the respective audio recorder component 502 and video recorder component 104. Subsequently, video data 504, audio data 506, and sensor data 508 are sent to smart seek module 110.

Consistent with various embodiments, smart seek module 110 may temporally align video data 504, audio data 506, and sensor data 508. In one example, frames of at least a portion of a video track that contains video data 504 are temporally mapped to portions of audio data 506 and sensor data 508. In this way, each of the video frames of the video track may be correlated with a corresponding portion of audio data 506 and sensor data 508. Subsequently, the smart seek module 110 may parse the resulting recorded event data, and assign significance values to each segment there (e.g., based on an analysis of one of more of video data 504, audio data 506, and sensor data 508). Smart seek module may then use the assigned significance values to generate a playback index for the video, as generally described above. System 500 may then replay the video recorded from event 102 in accordance with the playback speeds associated with each segment in the playback index.

In various different embodiments, smart seek module 110 may generate a playback index by applying different procedures or algorithms for assigning significance values to segments of recorded event data. For example, smart seek module 110 may be configured to adjust a first significance value for each segment of recorded event data based on an analysis of video and/or sensor data, as discussed above. Alternatively or additionally, a significance value and/or an adjustment to as first significance value may be set by smart seek module based on a combination of factors within video and sensor data. For example, as smart seek module consistent with the present disclosure may be configured to leave a first significance value of a segment unchanged, unless a combination of significance enhancing factors are detected from data in a segment. Without limitation, suitable combinations of significance enhancing factors include multiple sensor values exceeding a predetermined threshold, the detection of multiple pieces of biometric information matching one or more templates, the detection of a combination of biometric information and a threshold difference in sensor values, combinations thereof, and the like.

In the embodiment of FIG. 5A, smart seek module 110 may he configured to analyze video data 504, audio data 506, and sensor data 508 of each segment of recorded event information for significance enhancing factors. For example, smart seek module 110 may apply facial recognition techniques to detect the presence of faces within video data 504 and audio recognition techniques to detect the presence of specified audio in audio data 506. Likewise, smart seek module 110 may analyze sensor data 508 for significance factors, as generally discussed above.

The type and nature of the analysis performed by smart seek module 110 and/or the manner in which significance values are assigned may in some embodiments be determined by control factors in a control profile (not shown). For example, a control profile may include control factors specifying that the smart seek module is to analyze video data 504, audio data 506, and sensor data 508 within each segment of recorded event data, and compare such data to corresponding video, audio, and sensor data thresholds and/or biometric reference information (if needed). In some embodiments, the control factors may further specify that the smart seek module may increase or decrease a default value applied to the segment when any, all, or a combination of video data 504, audio data 506 and sensor data 506 includes a significance enhancing factor. Put in other terms, the smart seek module may be configured to enforce control parameters in the control profile as it proceed to assign a significance value to a segment. Accordingly, altering the control parameters may effectively change the manner in which the smart seek module determines and/or assigns significance values.

FIG, 5B is a block diagram of another video review system 520 consistent with the present disclosure. As shown, video review system 520 similar to that of FIG. 5A except insofar as two sensor components 106a and 106b are coupled to smart seek module 110 for the purposes of providing respective sensor data 522 and 524. Smart seek module 110 may thereby treat audio data 506, sensor data 522 and sensor data 524 in concert in order to assign significance values to segments of recorded event data and produce a playback index.

FIG. 5C is a block diagram of yet another video review system 560 consistent with the present disclosure. Video review system 520 is similar to that of FIG. 5B except insofar as audio recorder 502 is omitted. Smart seek module 110 may therefore treat sensor data 522 and sensor data 524 in concert in order to assign significance values to each segment of recorded event data from event 102, and to produce a playback index.

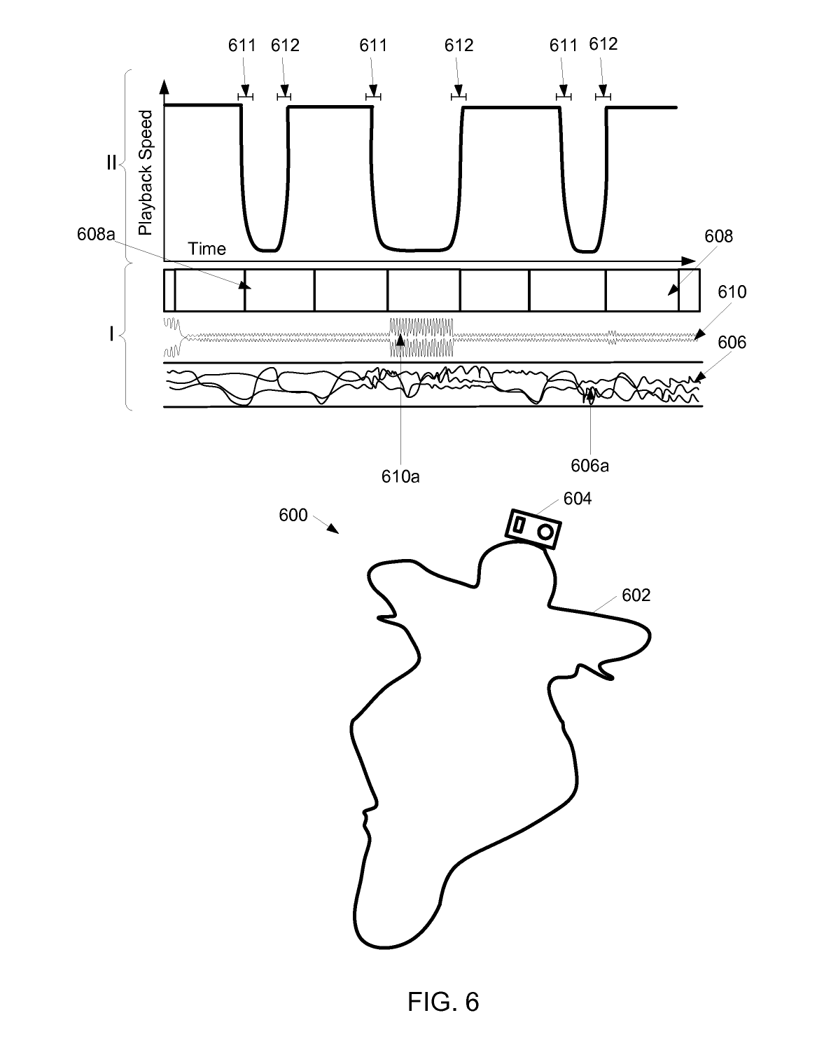

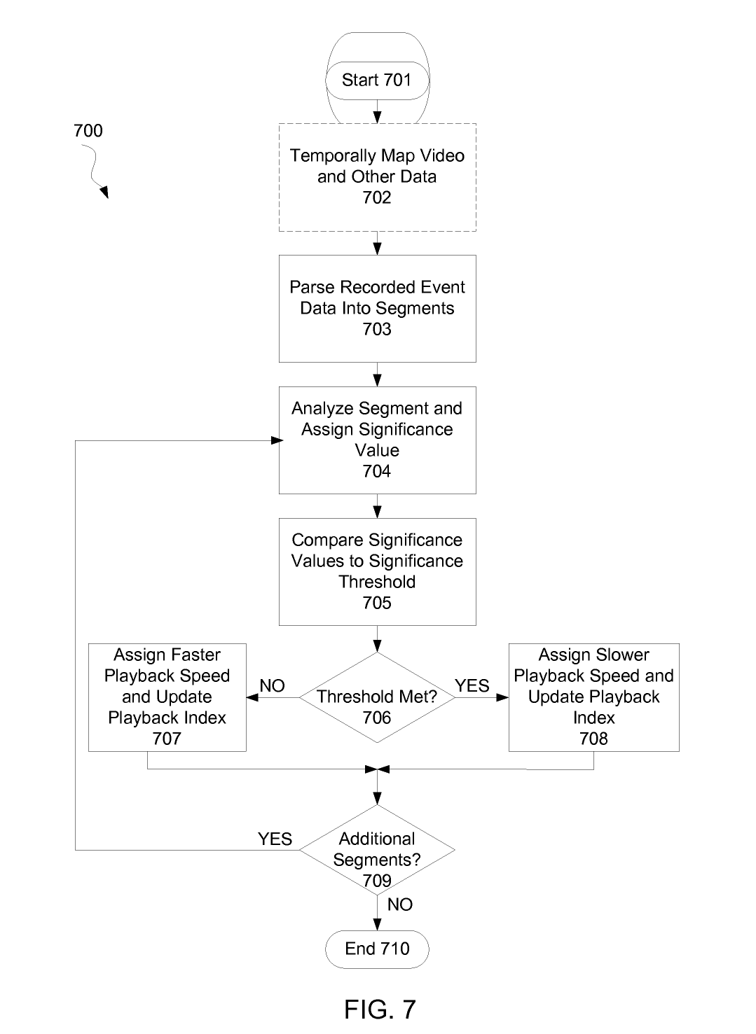

FIG. 6 depicts a non-limiting use case for a video review system consistent with the present disclosure. In particular, FIG. 6 depicts a use case wherein event 600 (in this case, a motorcycle ride) is recorded by an apparatus that includes a video recording device, audio recording device, and motion sensor such as an accelerometer attached to a motorcycle rider 602. More specifically, rider 602 is equipped with a head-mounted video camera 604 that includes both a microphone and acceler/meter (not shown). During a motorcycle ride, video data from the rider's perspective is recorded by video camera 604 and stored in memory. In addition, an audio track may he recorded and saved as audio data 610 to accompany the video data 608. Finally, accelerometer data may be collected and saved as sensor data 606 to accompany video data 608 and audio data 610.

Subsequently, sensor data 606, audio data 608, and video data 610 may be transferred to a video review system consistent with the present disclosure for processing. Once transferred, the video review system may temporally align video data 610, audio data 608, and sensor data 606 to produce recorded event data I. A smart seek module (not shown) in the video review system may (optionally in response to a user input) parse recorded event data I into a plurality of segments of a specified length (not shown). The smart seek module may then assign or adjust significance values to each of the segments based on an analysis of any or all of video data 610, audio data 608 and sensor data 606.

For example, the smart seek module may analyze sensor data 606 (e.g., accelerometer data) of each segment to determine whether or not such data meets or exceeds a predetermined threshold. As may be appreciated, segments of the recorded event information that included sensor data meeting such a threshold may signify the occurrence of a potentially interesting event, such as a jump by rider 602. In the embodiment of FIG. 6, a smart seek module may determine that sensor data 606a includes accelerometer values that exceed a predetermined threshold. The smart seek module may therefor assign a relatively high significance value (or may upwardly adjust a first significance value) to a segment containing that data. Similar operations may be performed by the smart seek module on audio data 610 and video data 608. In the illustrated embodiment, the smart seek module may determine that the segments of recorded event video I including audio data 610 and video data 608a exceed corresponding predetermined thresholds, and thus may assign a relatively high significance (or upwardly adjust a first significance value) to such segments. Other segments of the recorded event data may include video and/or sensor data that does not exceed a relevant threshold, and thus may be assigned a relatively low significance value by the smart seek module.

Following the assignment of significance values, the smart seek module may compare the significance values of each segment to one or more threshold significance values, wherein each threshold significance value is associated with a corresponding playback speed. In the embodiment of FIG. 6, segments having significance values exceeding a threshold significance value may be associated with a relatively slow (e.g., 1×) playback speed, whereas segments with significance values below the threshold significance value may he associated with a relatively high (e.g., 32×) playback speed. This concept is illustrated by region of FIG. 6, which plots playback speed vs. time (e.g., segment) for the recorded event information I shown, segments including sensor data 606a, audio data 608a, and video data 610a are associated with as relatively slow playback speed, whereas other segments are associated with a relatively high playback speed.

The resulting playback index (graphically depicted by region II of FIG. 6) may then be used by a video playback system to enhance the viewing of the video recorded by video camera 604. For example, upon initiation of smart seek function in the video review system, the system may play back the video recorded by video camera 604 in accordance with the /playback index described earlier. In this way, the video review system may replay relatively uninteresting portions of video at high speed and automatically slow video playback down to a relatively low speed at relatively interesting portions of the video, and then resume high speed playback when the relatively interesting portion of the video is over.

In various additional embodiments a smart seek module may be operative to adjust analysis procedures for assigning or adjusting significance values. For example, the smart seek module(s) described herein may he operative to adjust the criterion for determining the occurrence of a significance enhancing event from, recorded event data. Such adjustment may for example, be in response to a user input for a significance enhancing event.

By way of example, a smart seek module may in some embodiments apply a first threshold criterion to determine when a segment of recorded event data includes a significance enhancing event, and proceed to automatically assign significance values to segments based on the application of the first threshold. However, a user may review the video and/or playback index generated using, the first threshold and manually adjust the significance values applied to one or more segments, e.g. in instances where a segment is determined to be interesting (or uninteresting) to the user. The smart seek module may treat the manual reduction of significance values as an indication of false positive classification of significance enhancing events, and may adjust the threshold criterion for identifying significance enhancing events. For example, the smart seek module may increase a first threshold criterion for sensor changes, so as to reduce the number of significance enhancing events identified based on sensor data. Similarly, manual increases of significance values may be considered an indication of a false negative classification of significance enhancing events. In such instance, the smart seek module may decrease a first threshold criterion for sensor changes, so as to increase the number of significance enhancing events identified based on sensor data. In either case, these adjustments may have a downstream impact on the assignment of significance values to segments of recorded event data.

Although the present disclosure envisions systems and method in which the playback speed of a video changes instantaneously or within a very short period of time in accordance with a playback index, other options are available that may provide a more desirable user experience. More particularly, the smart seek module(s) described herein may be configured to define playback indexes that result in changes to playback speed that are more gradual or that occur in accordance with as mathematical function.

In this regard, the smart seek module(s) described herein may be configured in some embodiments to parse recorded event data into a plurality of segments, assign significance values, compare the significance values to one or more significance threshold, and assign first and second (and/or third, fourth, etc.) playback speeds to each segment based on the comparison with the significance thresholds, as discussed above. In addition, the smart seek module(s) may cause the playback system to identify first and second segments that are adjacent or within relatively close proximity to one another (e 0 within 1, 2, 5, 10 or 20 segments), wherein the first segment is assigned the first (relatively fast slow) playback speed and the second segment is assigned the second (relatively slow) playback speed. Once identified, the smart seek module(s) described herein may classify at least a portion of both of such segments as a first transition segment. The smart seek module-(s,) may then cause the system to assign a third playback speed to the first transition segment(s). This concept is illustrated in FIG. 6, wherein first transition segments 611 have been identified in association with first and second segments that are assigned second (relatively fast) and first (relatively slow) playback speeds, respectively.

As shown in FIG. 6, the third playback speed may be a variable playback speed that transitions from the second (relatively fast) playback speed to the first (relatively slow) playback speed. In some embodiments, the third playback speed may transition from the second to the first playback speeds in accordance with a mathematical function, such as a linear function of playback speed versus time, an exponential function of playback speed versus time, a logarithmic function of playback speed versos time, combinations thereof and the like. In this manner, the smart seek module(s) described herein may produce a playback index with a smooth transition between relatively fast playback speeds to relatively slow playback speeds.

The smart seek module(s) described herein may similarly define transition segments with variable playback speed to transition from a first (relatively slow) playback speed to a second (relatively fast) playback speed. In this regard, the smart seek module(s) described herein may cause a video playback system to identify third and fourth segments of the plurality of segments of recorded event information, wherein the third segment is assigned the first (relatively slow) playback speed and the fourth segment is assigned the second (relatively fast) playback speed. Once identified, the smart seek module(s) described herein may classify at least a portion of the third and fourth segments as a second transition segment. The smart seek module may then cause the system to assign a fourth playback speed to the second transition segments). This concept is illustrated in FIG. 6 wherein second transition segments 612 have been identified in association with third and fourth segments that are assigned second (relatively slow) and first (relatively) playback speeds, respectively.

Like the third playback speed, the fourth playback speed may be a variable playback speed. This concept is shown in FIG. 6, wherein the fourth playback speed assigned to second transition segment(s) 612 transition from the first (relatively slow) playback speed to the second (relatively fast) playback speed. Also like the third playback speed, the fourth playback speed may in some embodiments the first to the second playback speeds in accordance with a mathematical function, such as a linear function of playback speed versus time, an exponential function of playback speed versus time, a logarithmic function of playback speed versus time, combinations thereof and the like, in this manner, the smart seek module(s) described herein may produce a playback index with a smooth transition between relatively fast playback speeds to relatively slow playback speeds.

In some embodiments the smart seek module may be configured so as to “smooth” or omit the transition between a relatively fast and relatively slow playback speed, e.g., so as to enhance user experience. By way of example, the smart seek module may in some embodiments analyze amount of time between a first interesting segment, a second relatively uninteresting segment, and a third interesting segment, and identify or omit identification of a transition segment based on such analysis. Thus for example, if the second segment is between the first and third segments and is relatively short (e.g., less than about 10, 5 or even 1 second), the smart seek module may be configured so as to avoid identifying the first to second and second to third segments as transition segments. Put in other terms, the smart seek module may he configured to compare the length of an second uninteresting segment between adjacent first and third interesting segments to a transition threshold, and assign a playback speed to the uninteresting segment based on that comparison. For example, if the length of the second segment is below the transition threshold, the smart seek module may assign the same playback speed to the second segment as it did to the first and/or third segments, respectively.

Another aspect of the present disclosure relates to computer implemented methods for enhancing the playback of video. Several flow charts are therefore provided, and outline certain exemplary methods consistent with the present disclosure. While, for purposes of simplicity of explanation, methods of the present disclosure are presented in the form of a flow chart or flow diagram and described as a series of acts, it is to be understood and appreciated that the methods are not limited by the order of acts indeed in some embodiments, acts described herein in conjunction with the methods may be performed in an order other than what is presented in the flow diagrams and described herein.

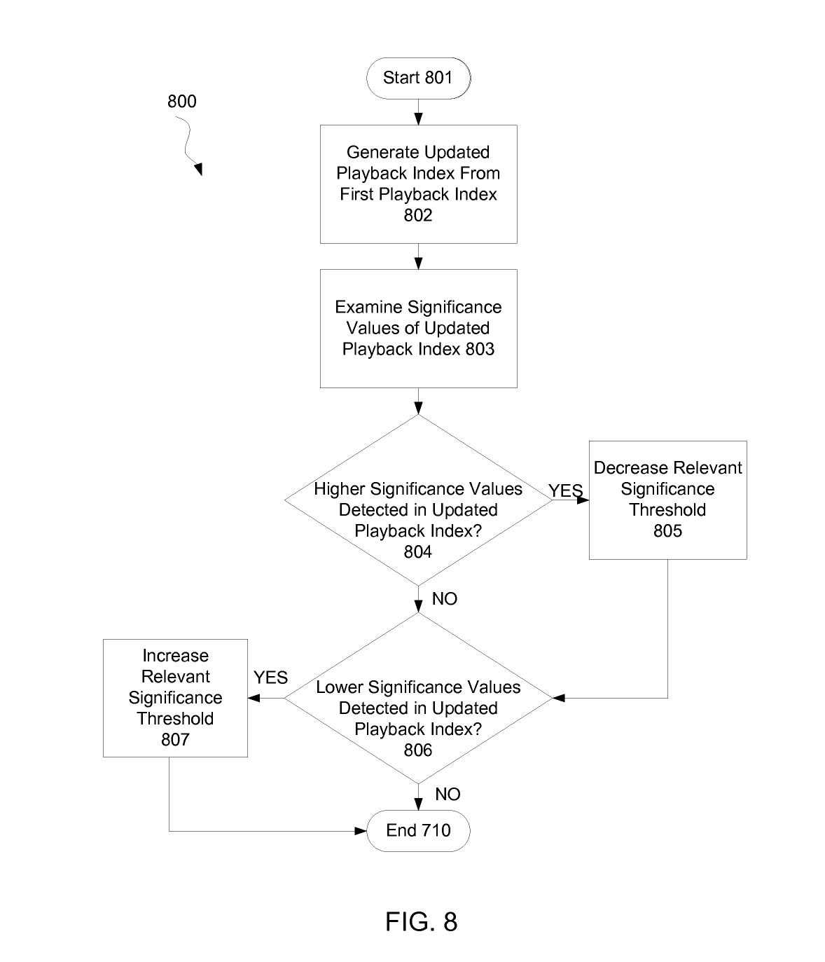

Reference is therefore made to FIG. 8, which depicts as flow diagram of an exemplary method for producing a playback index consistent with the present disclosure. For the sake of example, it is assumed that video, sensor and/or other data of an event has been recorded and transferred to a system consistent with the present disclosure.

As shown, method 700 begins at block 701. At optional block 702, a smart seek module or other module may temporally map video and other data to one another, e.g., as described previously. Once such mapping is complete (or if the data was previously mapped) the method may proceed to block 703, wherein the mapped data (recorded event data) may be parsed into a plurality of segments, as previously described.

The method may then proceed to block 704, wherein the video and other data within each segment may be analyzed for the presence of a significance enhancing event. Such analysis may be performed by processing the recorded event data within a segment to identify changes in data values, the presence of biometric information, combinations thereof and the like, as generally described above. Based on the analysis of the recorded event data within a segment, a significance value may be assigned to that segment. Alternatively or additionally, a first significance value for the segment may be increased or decreased depending, on the results of the analysis. Such processing may repeat for all segments of the recorded event data. Alternatively, processing pursuant to block 704 may occur on a segment by segment basis as shown in FIG, 7, wherein the operations of blocks 704-708 are completed for one segment before processing of another segment begins. Of course, processing of multiple segments concurrently is also possible, provided the smart seek module and/or video review system can support it.

In any case, the method may proceed to block 705, wherein a significance value assigned to a segment is compared to one or more significance thresholds, as described above. Then pursuant to block 706 a decision is made as to whether the significance value assigned to a segment exceeds a significance threshold. If not, the method may proceed to block 707, wherein a second (relatively fast) playback speed is associated with the segment, and a playback index for the recorded video data is updated to reflect that association. Alternatively if the significance value assigned to a segment exceeds a significance threshold, the method may proceed to block 708 wherein a first (relatively slow) playback speed is associated with the segment and a playback index for the recorded video data is updated accordingly.

The method may then proceed to block 709, wherein a determination is made as to whether additional segments of recorded event data are available to process. If so, the method loops hack to block 704 and repeats for the additional segment(s). If no additional segments are available for processing (i.e., the end of the recorded event data has been reached), the method may proceed to block 710 and end.

FIG. 8 depicts an exemplary method for updating a playback index consistent with the present disclosure. For the sake of illustration, it is assumed that a first playback index for recorded event data has been previously produced. With this in mind, method 800 begins at block 801. At block 802, an updated playback index may he generated from a first playback index, e.g., by storing changes that were manually (or otherwise) entered into the system. For example, a user may manually input changes to a first playback index alternatively or additionally, a user may change control parameters that affect the manner in which a smart seek module assigns significance values, which in turn may alter the significance values assigned to segments of recorded event information, relative to the significance values that were determined before such changes were entered.

In any case, the method may proceed to block 803, wherein the significance values of the updated playback index may be compared to those of the first playback index. Pursuant to block 804, a determination may that be made as to whether higher significance values were detected in the updated playback index. If so, the method may proceed to block 805, wherein the system may decrease a relevant significance threshold. This may increase the number of events in recorded event data that are identified as potentially interesting based on the changed significance threshold, e.g., which may result in the system identifying interesting events that it missed when preparing the first playback index.

Once the operations pursuant to block 805 are complete, or if higher significance values were not detected in the updated playback index, the method pay proceed to block 806 wherein a determination is made as to whether lower significance values were detected in the updated playback index relative to the first playback index if so, the method may proceed to block 807, wherein a relevant significance threshold may be increased. This may decrease the number of events in recorded event data that are identified as potentially interesting based on the changed significance threshold, e.g., which may cause the system to avoid identifying certain events that it identified when preparing the first playback index as potentially interesting.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

### EXAMPLES

Examples of the present disclosure include subject matter such as a devices/apparatus, computer implemented methods, means for performing acts of the method, and at least one machine-readable medium including instructions that when performed by a machine cause the machine to perform acts of the method as discussed below.

### Example 1

According to this example there is provided an apparatus for enhancing video playback, including: a processor; and a smart seek module operative on the processor to: parse recorded event, data into a plurality of segments, the recorded event data including video :data and sensor data mapped to Video frames of the video data assign significance values to each segment of the plurality of segments; compare the significance value of each segment of the plurality of segments to a first significance threshold; assign a first playback speed to each segment of the plurality of segments having a significance value exceeding the first significance threshold: assign a second playback speed to each segment of the plurality of segments having a significance value below the first significance threshold, the second playback speed being greater than the first playback speed; and generate a playback index to identify each of the plurality of segments with a corresponding playback speed.

### Example 2

This example includes the elements of example 1, wherein the sensor data includes data recorded by at least one of an accelerometer, an audio sensor, a gyrometer, a global positioning system, a pressure sensor, a light sensor, a humidity sensor, a biometric sensor, and an audio sensor.

### Example 3

This example includes the elements of examples 1 or 2, wherein the smart seek module is further operative on the processor to assign a significance value to each segment of the plurality of segments based at least in part on control parameters within a control profile.

### Example 4

This example includes the elements of example 3, wherein the control parameters cause the smart seek module to assign a significance value to each segment of the plurality of segments based on an analysis of the video data, the sensor data, or a combination thereof within the segment.

### Example 5

This example includes the elements of any one of examples 3 and 4, wherein the control parameters cause the smart seek module to assign a significance value to each segment of the plurality of segments by: assigning a first significance value to each of the plurality of segments; monitoring the sensor data as a function of time within the plurality of segments; and increasing or decreasing the first significance value assigned to a segment of the plurality of segments when the value of sensor data vs. time or rate of change of the value of sensor data vs, time deviates from the value of sensor data value vs. time or rate of change of sensor data value vs. time in an immediately prior segment by a predetermined threshold.

### Example 6

This example includes the elements of any one of examples 4 and 5, wherein the control parameters cause the smart seek module to assign a significance value to each segment of the plurality of segments by: assigning a first significance value to each of the plurality of segments; monitoring the sensor data as a function of time within each of the plurality of segments; and increasing or decreasing the first significance value assigned to segments in which a sign of the sensor data changes.

### Example 7

This example includes the elements of any one of examples 4 to 6, wherein the control parameters cause the smart seek module to assign a significance value to each segment of the plurality of segments by assigning first significance value to each of the plurality of segments; analyzing the video and sensor data within the segment for the presence of biometric information; increasing the first significance value assigned to a segment if the biometric information is detected: and decreasing the first significance value assigned to a segment if the biometric information is not detected.

### Example 8

This example includes the elements of any one of examples 1 to 3, wherein the smart seek module is further operative on the processor to assign a significance value to each segment of the plurality of segments based at least in part on a combination of the video and the sensor data within a corresponding respective segment of the plurality of segments.

### Example 9

This example includes the elements of any one of examples 1 to 8, wherein the smart seek module is further operative on the processor to: identify adjacent first and second segments of the plurality of segments, where-in the first segment is assigned the second playback speed and the second segment is assigned the first playback speed; classify portions of the recorded event data encompassing at least a portion of the- first and second segments as a first transition segment; and assign a third playback speed to each first transition segment.

### Example 10

This example includes the elements of example 9, wherein the third playback speed is a variable playback speed.

### Example 11

This example includes the elements of any one of examples 9 and 10, wherein the third playback speed decreases the second playback speed to the first playback speed within the first transition segment in accordance with at least one of a linear function of playback speed versus time, an exponential function of playback speed versus time, and a logarithmic function of playback speed versus time.

### Example 12

This example includes the elements of any one of examples 9 to 11, wherein the smart :seek module is further operative on the processor to: identify adjacent third and fourth :segments of the plurality of segments, wherein the third segment is assigned the first playback speed and the fourth segment is assigned the second playback speed; classify portions of the recorded event data encompassing at least a portion of the third and fourth segments as a second transition segment; and assign a fourth playback speed to each second transition segment.

### Example 13

This example includes the elements of example 12, wherein the fourth playback speed is a variable playback speed.

### Example 14

This example includes the elements of any one of examples 12 and 13, wherein the fourth playback speed increases the first playback speed to the second playback speed in accordance with at least one of a linear function of playback speed versus time, an exponential function of playback speed versus time, and a logarithmic function of playback speed versus time.

### Example 15

This example includes the elements of any one of examples 12 to 14, wherein the second segment and the third segment are the same segment of the plurality of segments.

### Example 16

This example includes the elements of any one of examples 1 to 15, wherein the smart seek module is further operative on the processor to: compare the significance value of each of the plurality of segments to a second significance threshold, the second significance threshold being greater than the first significance threshold; and assign a fifth playback speed to each segment of the plurality of segments having a significance value exceeding the second significance threshold, the fifth playback speed being less than the first playback speed.

### Example 17

This example includes the elements of any one of examples 1 to 16, wherein the smart seek module is further operative on the processor to: compare the Significance value of each of the plurality Of segments to a third significance threshold, the third significance threshold being less than the first significance threshold; and assign a sixth playback speed to each segment of the plurality of segments having a significance value below the third significance threshold, the sixth playback speed being greater than the first playback speed.

### Example 18

This example includes the elements of any one of examples 1 to 17, wherein the smart seek module is further operative on the processor to: generate an updated playback index by storing a set of manually entered changes to the playback index; and modify a procedure to assign significance values to the plurality of segments in accordance with the manually entered changes.

### Example 19

According to this example there is a provided a computer readable medium including instructions for enhancing video playback, wherein the instructions when executed by a system cause the system to: parse recorded event data into a plurality of segments, the recorded event data including video data and sensor data mapped to video frames of the video data; assign a significance value to each segment of the plurality of segments; compare the significance value of each segment of the plurality of segments to a first significance threshold; assign a first playback speed to each segment of the plurality of segments having a significance value exceeding the first significance threshold: assign a second playback speed to each segment of the plurality of segments having a significance value below the first significance threshold, the second playback speed being greater than the first playback speed; and generate a playback index to identify each of the plurality of segments with a corresponding playback speed.

### Example 20

This example includes the elements of example 19, wherein the sensor data includes data recorded by at least one of an accelerometer, an audio sensor, a gymnieter, a global positioning system, a pressure sensor, a light sensor, a humidity sensor, a biometric sensor, and an audio sensor.

### Example 21

This example includes the elements of any one of examples 20 and 21, wherein the instructions when executed further cause the system to assign a significance value to each segment of the plurality of segments based at least in part on control parameters contained within a control profile.

### Example 22

This example includes the elements of example 21, wherein the control parameters specify the assignment of significance values to each segment of the plurality of segments based at least in part on an analysis of the video data, the sensor data, or a combination thereof within a corresponding segment of the plurality of segments.

### Example 23

This example includes the elements of any one of examples 21 and 22, wherein the control parameters specify a predetermined threshold, and the computer readable instructions when executed further cause the system to: assign a first significance value to each segment of the plurality of segments; monitor the sensor data as a function of time within each of the plurality of segments; and increase or decrease the first significance value assigned to a segment when the value of sensor data vs. time or rate of change of the value of sensor data vs, time deviates from the value of sensor data value vs. time or rate of change of sensor data value vs, time in an immediately prior segment by the predetermined threshold.

### Example 24

This example includes the elements of any one of examples 22 to 23, wherein the instructions when executed further cause the system to: assign a first significance value to each segment of the plurality of segments: monitor the sensor data as a function of time within a segment of the plurality of segments: increase or decrease the first significance value assigned to the segment in which a sign of the sensor data changes.

### Example 25

This example includes the elements of any one of examples 22 to 24, wherein the control parameters specify the assignment of significance values based at least in part on the presence of biometric information in the recorded event data, wherein the instructions when executed further cause the system to assign the significance values by: assigning a first significance value to each of the plurality of segments; analyzing the video and sensor data within each of the plurality of segments for the presence of the biometric information; increasing the first significance value assigned to a segment of the plurality of segments in which the biometric information is detected; and decreasing the first significance value assigned to a segment of the plurality of segments in which the biometric information is not detected.

### Example 26

This example includes the elements of any one of examples 19 to 25, wherein the instructions when executed further cause the system to assign the significance value to each segment of the plurality of segments based at least in part on a combination of the video and the sensor data within a corresponding respective segment of the plurality of segments.

### Example 27

This example includes the elements of any one of examples 19 to 26, wherein the instructions when executed further cause the system to: identify adjacent first and second segments of the plurality of segments, wherein the first segment is assigned the second playback speed and the second segment is assigned the lust playback speed: classify portions of the recorded event data encompassing at least a portion of the first and second segments as a first transition segment; and assign a third playback speed to each first transition segment.

### Example 28

This example includes the elements of example 27, wherein the third playback speed is a variable playback speed.

### Example 29

This example includes the elements of any one of examples 27 and 28, wherein the third playback speed decreases the second playback speed to the first playback speed within the first transition segment in accordance with at least one of a linear function of playback speed versus time, an exponential function of playback speed versus time, and a logarithmic function of playback speed versus time.

### Example 30

This example includes the elements of any one of examples 27 to 29, wherein the instructions when executed further cause the system to: identify adjacent third and fourth segments of the plurality of segments, wherein the third segment is assigned the first playback speed and the fourth segment is assigned the second playback speed; classify portions of the recorded event data encompassing at least a portion of the third and fourth segments as a second transition segment; and assign a fourth playback speed to each second transition segment.

### Example 31

This example includes the elements of example 30, wherein the fourth playback speed is a variable playback speed.

### Example 32

This example includes the elements of any one of examples 30 and 31, wherein the fourth playback speed increases the first playback speed to the second playback speed in accordance with at least one of a linear function of playback speed versus time, an exponential function of playback speed versus time, and a logarithmic function of playback speed versus time.

### Example 33

This example includes the elements of any one of examples 30 to 32, wherein the second segment and the third segment are the same segment of the plurality of segments.

### Example 34

This example includes the elements of any one of examples 19 to 33, wherein the instructions when executed further cause the system to: compare the significance value of each of the plurality of segments to a second significance threshold, the second significance threshold being greater than the first significance threshold; and assign a fifth playback speed to each segment of the plurality of segments having a significance value exceeding the second significance threshold, the fifth playback speed being less than the first playback speed.

### Example 35

This example includes the elements of any one of examples 19 to 34, wherein the instructions when executed further cause the system to: compare the significance value of each of the plurality of segments to a third significance threshold, the third significance threshold being less than the first significance threshold; and assign a sixth playback speed to each segment of the plurality of segments having a significance value below the third significance threshold, the sixth playback speed being greater than the first playback speed.

### Example 36

This example includes the elements of any one of examples 19 to 35, wherein the instructions when executed further cause the system to: generate an updated playback index by storing a set of manually entered changes to the playback index; and modify a procedure to assign significance values to the plurality of segments in accordance with the manually entered changes.

### Example 37

According to this example there is provided a computer implemented method for enhancing video playback, including: parsing recorded event data into a plurality of segments, the recorded event data including video data and sensor data mapped to video frames of the video data assigning a significance value to each segment of the plurality of segments comparing the significance value of each segment of the plurality of segments to a first significance threshold; assigning a first playback speed to each segment of the plurality of segments having a significance value exceeding the first significance threshold; assigning a second playback speed to each segment of the plurality of segments having a significance value below the first significance threshold, the second playback speed being greater than the first playback speed; and generating a playback index to identify each of the plurality of segments with a corresponding playback speed.

### Example 38

This example includes the elements of example 37, wherein the sensor data includes data recorded by at least one of an accelerometer, an audio sensor, a gyrometer, a global positioning system, a pressure sensor, a light sensor, a humidity sensor, a biometric sensor, and an audio sensor.

### Example 39

This example includes the elements of any one of examples 37 to 39, wherein the control parameters specify the assignment of significance values to each segment of the plurality of segments based on an analysis of the video data, the sensor data, or a combination thereof within a corresponding segment of the plurality of segments.

### Example 40

This example includes the elements of any one of examples 37 to 39, wherein the control parameters specify the assignment of significance values to each segment of the plurality of segments based at least in part on an analysis of the video data, the sensor data, or as combination thereof within as corresponding segment of the plurality of segments.

### Example 41

This example includes the elements of example 40, wherein the control parameters specify a predetermined threshold, and assigning the significance values includes: assigning a first significance value to each segment of the plurality of segments: monitoring the sensor data as a function of time within each of the plurality of segments; and increasing or decreasing the first significance value assigned to a segment when the value of sensor data vs. time or rate of change of the value of sensor data vs, time deviates from the value of sensor data value vs. time or rate of change of sensor data value vs. time in an immediately prior segment by the predetermined threshold.

### Example 42

This example includes the elements of any one of examples 40 and 41, wherein assigning the significance values includes: assigning a first significance value to each segment of the plurality of segments: monitoring the sensor data as a function of time within a segment of the plurality of segments; and increasing or decreasing the first significance value assigned to the segment in which a sign of the sensor data changes.

### Example 43

This example includes the elements of any one of examples 40 to 42, wherein the control parameters specify the assignment of significance values based on the presence of biometric information in the recorded event data, and assigning the significance values includes: assigning a first significance value to each segment of the plurality of segments: analyzing the video and sensor data within each of the plurality of segments, for the presence of the biometric information: increasing the first significance value assigned to a segment of the plurality of segments in which the biometric information is detected: and decreasing the first significance value assigned to a segment of the plurality of segments in which the biometric information is not detected.

### Example 44

This example includes the elements of any one of examples 37 to 44, wherein assigning the significance value is performed based on an analysis of a combination of the video and the sensor data within a corresponding respective segment of the plurality of seoments.

### Example 45

This example includes the elements of any one of examples 37 to 44, further including: identifying adjacent first and second segments of the plurality of segments, wherein the first segment is assigned the second playback speed and the second segment is assigned the first playback speed; classifying portions of the recorded event data encompassing at least a portion of the first and second segments as a first transition segment; and assigning a third playback speed to each first transition segment.

### Example 46

This example includes the elements of example 45, wherein the third playback speed is a variable playback speed.

### Example 47

This example includes the elements of any one of examples 45 and 46, wherein the third playback speed decreases the second playback speed to the first playback speed within the first transition segment in accordance with at least one of a linear function of playback speed versus time, an exponential function of playback speed versus time, and as logarithmic function of playback speed versus time.

### Example 48

This example includes the elements of any one of examples 45 to 47, and further includes identifying adjacent third and fourth segments of the plurality of segments, wherein the third segment is assigned the first playback speed and the fourth segment is assigned the second playback speed; classifying portions of the recorded event data encompassing at least a portion of the- third and fourth segments as a second transition segment; and assigning a fourth playback speed to each second transition segment.

### Example 49

This example includes the elements of example 48, wherein the fourth playback speed is a variable playback speed.

### Example 50

This example includes the elements of any one of examples 48 and 49, wherein the fourth playback speed increases the first playback speed to the second playback speed in accordance with at least one of a linear function of playback speed versus time, an exponential function of playback speed versus time, and a logarithmic function of playback speed versus time.

### Example 51

This example includes the elements of any one of examples 48 to 50, wherein the second segment and the third segment are the same segment of the plurality of segments.

### Example 52

This example includes the elements of any one of examples 37 to 51, and further includes: comparing the significance value of each of the plurality of segments to a second significance threshold, the second significance threshold being greater than the first significance threshold; and assigning a fifth playback speed to each segment of the plurality of segments having a significance value exceeding the second significance threshold, the fifth playback speed being less than the first playback speed.

### Example 53

This example includes the elements of any one of examples 37 to 51, and further includes: comparing the significance value of each of the plurality of segments to a third significance threshold, the third significance threshold being less than the first significance threshold: and assigning a sixth playback speed to each segment of the plurality of segments having, a significance value below the third significance threshold, the sixth playback speed being greater than the first playback speed.

### Example 54

This example includes the elements of any one of examples 37 to 51, and further includes: generating an updated playback index by storing a set of manually entered changes to the playback index; and modifying a procedure to assign significance values to the plurality of segments in accordance with the manually entered changes.

### Example 55

This example includes the elements of any one of examples 3 to 5, wherein enforcement of the control parameters causes the smart seek module to assign a significance value to each segment of the plurality of segments by: assigning, a first significance value to each of the plurality of segments; analyzing the video and sensor data within each of the plurality of segments with a machine learning classifier; and increasing or decreasing the first significance value assigned to each segment of the plurality of segments based on the analysis.

### Example 56

This example includes the elements of any one of examples 22 to 25, wherein the control parameters specify the assignment of significance values based on the presence of biometric information in the recorded event data, and wherein the instructions when executed further cause the system to assign the significance values by assigning a first significance value to each of the plurality of segments; analyzing the video and sensor data within each of the plurality of segments with a machine learning classifier; and increasing or decreasing the first significance value assigned to each segment of the plurality of segments based on the analysis.

### Example 57

This example includes the elements of any one of claims 40 to 43, wherein the control parameters specify a predetermined threshold, and assigning the significance values includes: assigning a first significance value to each segment of the plurality of segments; analyzing the video and sensor data within each of the plurality of segments with a machine learning classifier; and increasing or decreasing the first significance value assigned to each segment of the plurality of segments based on the analysis.

### Example 58

In this example there is provided a system for enhancing video playback including at least one device arranged to perform the method according to any one of examples 37 to 57.

### Example 59

In this example there is provided a device for enhancing video playback including means to perform the method according to any one of examples 37 to 57.

### Example 60

In this example there is provided at least one machine readable medium that includes a plurality of instructions for enhancing video playback, wherein the instructions when executed on a computing device cause the computing device to perform the method according to any one of examples 37 to 57.

### Example 61

According to another example embodiment there is provided an apparatus for enhancing video playback including; means for parsing recorded event data into a plurality of segments, the recorded event data including video data and sensor data mapped to video frames of the video data; means for assigning a significance value to each segment of the plurality of segments; means for comparing the significance value of each segment of the plurality of segments to a first significance threshold; means for assigning a first playback speed to each segment of the plurality of segments having a significance value exceeding the first significance threshold; means for assigning a second playback speed to each segment of the plurality of segments having, a significance value below the first significance threshold, the second playback speed being greater than the first playback speed; and means for generating a playback index to identify each of the plurality of segments with a corresponding playback speed.

### Example 62

This example includes any or all of the elements of example 61, wherein the sensor data includes data recorded by at least one of an accelerometer, an audio sensor, a gyrometer, a global positioning system, a pressure sensor, a light sensor, a humidity sensor, a biometric sensor, and an audio sensor.

### Example 63

This example includes any or all of the elements of example 61, and further includes means for assigning a significance value to each segment of the plurality of segments based at least in part on control parameters within a control profile.

### Example 64

This example includes any or all of the elements of example 63, wherein the control parameters cause the means for assigning a significance value to assign a significance value to each segment of the plurality of segments based at least in part on an analysis of the video data, the sensor data, or a combination thereof within the segment.

### Example 65

This example includes any or all of the elements of example 64, wherein the control parameters cause the means for assigning a significance value to assign a significance value to each segment of the plurality of segments by: assigning a first significance value to each of the plurality of segments; monitoring the sensor data as a function of time within the plurality of segments; and increasing or decreasing the first significance value assigned to a segment of the plurality of segments when the value of sensor data vs, time or rate of change of the value of sensor data vs, time deviates from the value of sensor data value vs. time or rate of change of sensor data value vs, time in an immediately prior segment by a predetermined threshold.

### Example 66

This example includes any or all of the elements of example 64, wherein the control parameters cause the means for assigning a significance value to assign a significance value to each segment of the plurality of segments by: assigning a first significance value to each of the plurality of segments; monitoring, the sensor data as a function of time within each of the plurality of segments; and increasing or decreasing the first significance value assigned to segments in which as sign of the sensor data changes.

### Example 67

This example includes any or all of the elements of example 64, wherein the control parameters cause the means for assigning a significance value to assign a significance value to each segment of the plurality of segments by: assigning as first significance value to each of the plurality of segments: analyzing the video and sensor data within the segment for the presence of biometric information; increasing the first significance value assigned to a segment if the biometric information is detected; and decreasing the first significance value assiffied to a segment if the biometric information is not detected.

### Example 68

This example includes any or all of the elements of example 61, wherein the means for assigning a significance value is further operative to assign a significance value to each segment of the plurality of segments based at least in part on a combination of the video and the sensor data within a corresponding respective segment of the plurality of segments.

### Example 69

This example includes any or all of the elements of example 61, and further includes: means to identify adjacent first and second segments of the plurality of segments, wherein the first segment is assigned the second playback speed and the second segment is assigned the first playback speed means to classify portions of the recorded event data encompassing at least a portion of the first and second segments as a first transition segment; and means to assign a third playback speed to each first transition segment.

### Example 70

This example includes any or all of the elements of example 69, wherein the third playback speed is a variable playback speed.

### Example 71

This example includes any or all of the elements of example 69, wherein the third playback speed decreases the second playback speed to the first playback speed within the first transition segment in accordance with at least one of a linear function of playback speed versus time, an exponential function of playback speed versus time, and a logarithmic function of playback speed versus time.

### Example 72

This example includes any or all of the elements of example 69, and further includes means to identify adjacent third and fourth segments of the plurality of segments, wherein the third segment is assigned the first playback speed and the fourth segment is assigned the second playback speed; means to classify portions of the recorded event data encompassing at least a portion of the third and fourth segments as a second transition segment; and means to assign a fourth playback speed to each second transition segment.

### Example 73

This example includes any or all of the elements of example 72, wherein the fourth playback speed is a variable playback speed.

### Example 74

This example includes any or all of the elements of example 72, wherein the fourth playback speed increases the first playback speed to the second playback speed in accordance with at least one of a linear function of playback speed versus time, an exponential function of playback speed versus time, and a logarithmic function of playback speed versus time.

### Example 75

This example includes any or all of the elements of example 72, wherein the second segment and the third segment are the same segment of the plurality of segments.

### Example 76

This example includes any or all of the elements of any one of examples 61 to 75, and further includes: means to compare the significance value of each of the plurality of segments to a second significance threshold, the second significance threshold being greater than the first significance threshold; and means to assign a fifth playback speed to each segment of the plurality of segments having a significance value exceeding the second significance threshold, the fifth playback speed being less than the first playback speed.

### Example 77

This example includes any or all of the elements of any one of examples 61 to 75, and further includes: means to compare the significance value of each of the plurality of segments to a third significance threshold, the third significance threshold being less than the first significance threshold; and means to assign a sixth playback speed to each segment of the plurality of segments having a significance value below the third significance threshold, the sixth playback speed being greater than the first playback speed.

### Example 78

This example includes any or all of the elements of any one of examples 61 to 75, and further includes: means to generate an updated playback index by storing a set of manually entered changes to the playback index; and means to modify a procedure to assign significance values to the plurality of segments in accordance with the manually entered changes.

Although the subject matter has been described in language specific to structural features and/or methodological acts, it is to he understood that the subject matter defined in the appended claims is not necessarily limited to the specific features or acts described above. Rather, the specific features and acts described above are disclosed as example forms of implementing the claims.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-25. (canceled)

26. An apparatus, comprising:
a processor; and
a smart seek module operative on the processor to:
parse recorded event data into a plurality of segments, said recorded event data comprising video data and sensor data mapped to video frames of said video data;
assign significance values to each segment of said plurality of segments;
compare the significance value of each segment of said plurality of segments to a first significance threshold;
assign a first playback speed to each segment of said plurality of segments having a significance value exceeding said first significance threshold;
assign a second playback speed to each segment of said plurality of segments having a significance value below said first significance threshold, the second playback speed being greater than the first playback speed; and
generate a playback index to identify each of said plurality of segments with a corresponding playback speed.

27. The apparatus of claim 26, wherein the sensor data comprises data recorded by at least one of an accelerometer, an audio sensor, a gyrometer, a global positioning system, a pressure sensor, a light sensor, a humidity sensor, a biometric sensor, and an audio sensor.

28. The apparatus of claim 26, wherein said smart seek module is further operative on said processor to assign a significance value to each segment of said plurality of segments based at least in part on control parameters contained within a control profile wherein said control parameters cause said smart seek module to assign a significance value to each segment of said plurality of segments based at least in part on an analysis of said video data, said sensor data, or a combination thereof within said segment.

29. The apparatus of claim 28, wherein said control parameters cause said smart seek module to assign a significance value to each segment of said plurality of segments by:
assigning a first significance value to each of said plurality of segments;
monitoring said sensor data as a function of time within said plurality of segments; and increasing or decreasing the first significance value assigned to a segment of said plurality of segments when the value of sensor data vs. time or rate of change of the value of sensor data vs. time deviates from the value of sensor data value vs. time or rate of change of sensor data value vs. time in an immediately prior segment by a predetermined threshold.

30. The apparatus of claim 28, wherein said control parameters cause said smart seek module to assign a significance value to each segment of said plurality of segments by:
assigning a first significance value to each of said plurality of segments;
analyzing said video and sensor data within said segment for the presence of biometric information;
increasing the first significance value assigned to a segment if said biometric information is detected; and
decreasing the first significance value assigned to a segment if said biometric information is not detected.

31. The apparatus of claim 26, wherein said smart seek module is further operative on said processor to:
identify adjacent first and second segments of said plurality of segments, wherein said first segment is assigned said second playback speed and said second segment is assigned said first playback speed;
classify portions of said recorded event data encompassing at least a portion of said first and second segments as a first transition segment; and
assign a third playback speed to each first transition segment, wherein said third playback speed is a variable playback speed.

32. The apparatus of claim 31, wherein said smart seek module is further operative on said processor to:
identify adjacent third and fourth segments of said plurality of segments, wherein said third segment is assigned said first playback speed and said fourth segment is assigned said second playback speed;
classify portions of said recorded event data encompassing at least a portion of said third and fourth segments as a second transition segment; and
assign a fourth playback speed to each second transition segment, wherein said fourth playback speed is a variable playback speed.

33. The apparatus of claim 32, wherein said smart seek module is further operative on said processor to:
compare the significance value of each of said plurality of segments to a second significance threshold and a third significance threshold, the second and third significance thresholds being greater than and less than said first significance threshold, respectively;
assign a fifth playback speed to each segment of said plurality of segments having a significance value exceeding said second significance threshold, the fifth playback speed being less than said first playback speed; and
assign a sixth playback speed to each segment of said plurality of segments having a significance value below said third significance threshold, the sixth playback speed being greater than said first playback speed.

34. A computer implemented method, comprising:
parsing recorded event data into a plurality of segments, said recorded event data comprising video data and sensor data mapped to video frames of said video data;
assigning a significance value to each segment of said plurality of segments;
comparing the significance value of each segment of said plurality of segments to a first significance threshold;
assigning a first playback speed to each segment of said plurality of segments having a significance value exceeding said first significance threshold;
assigning a second playback speed to each segment of said plurality of segments having a significance value below said first significance threshold, the second playback speed being greater than the first playback speed; and
generating a playback index to identify each of said plurality of segments with a corresponding playback speed.

35. The computer implemented method of claim 34, wherein the sensor data comprises data recorded by at least one of an accelerometer, an audio sensor, a gyrometer, a global positioning system, a pressure sensor, a light sensor, a humidity sensor, a biometric sensor, and an audio sensor.

36. The computer implemented method of claim 34, wherein assigning said significance values is performed in accordance with control parameters contained within a control profile, wherein said control parameters specify the assignment of significance values to each segment of said plurality of segments based at least in part on an analysis of said video data, said sensor data, or a combination thereof within a corresponding segment of said plurality of segments.

37. The computer implemented method of claim 36, wherein said control parameters specify a predetermined threshold, and assigning said significance values comprises:
assigning a first significance value to each segment of said plurality of segments;
monitoring said sensor data as a function of time within each of said plurality of segments; and
increasing or decreasing the first significance value assigned to a segment when the value of sensor data vs. time or rate of change of the value of sensor data vs. time deviates from the value of sensor data value vs. time or rate of change of sensor data value vs. time in an immediately prior segment by said predetermined threshold.

38. The computer implemented method of claim 36, wherein assigning said significance values comprises:
assigning a first significance value to each segment of said plurality of segments;
monitoring said sensor data as a function of time within a segment of said plurality of segments; and
increasing or decreasing the first significance value assigned to said segment in which a sign of said sensor data changes.

39. The computer implemented method of claim 36, wherein said control parameters specify the assignment of significance values based at least in part on the presence of biometric information in said recorded event data, and assigning said significance values comprises:
assigning a first significance value to each segment of said plurality of segments;
analyzing said video and sensor data within each of said plurality of segments for the presence of said biometric information;
increasing the first significance value assigned to a segment of said plurality of segments in which said biometric information is detected; and
decreasing the first significance value assigned to a segment of said plurality of segments in which said biometric information is not detected.

40. The computer implemented method of claim 34, further comprising:
identifying adjacent first and second segments of said plurality of segments, wherein said first segment is assigned said second playback speed and said second segment is assigned said first playback speed;
classifying portions of said recorded event data encompassing at least a portion of said first and second segments as a first transition segment; and
assigning a third playback speed to each first transition segment, wherein said third playback speed is a variable playback speed.

41. The computer implemented method of claim 40, further comprising:
identifying adjacent third and fourth segments of said plurality of segments, wherein said third segment is assigned said first playback speed and said fourth segment is assigned said second playback speed;
classifying portions of said recorded event data encompassing at least a portion of said third and fourth segments as a second transition segment; and
assigning a fourth playback speed to each second transition segment, wherein said fourth playback speed is a variable playback speed.

42. The computer implemented method of claim 36, further comprising:
comparing the significance value of each of said plurality of segments to a second significance threshold and a third significance threshold, the second and third significance thresholds being greater than and less than said first significance threshold, respectively;
assigning a fifth playback speed to each segment of said plurality of segments having a significance value exceeding said second significance threshold, the fifth playback speed being less than said first playback speed; and
assigning a sixth playback speed to each segment of said plurality of segments having a significance value below said third significance threshold, the sixth playback speed being greater than said first playback speed.

43. At least one computer-readable storage medium comprising instructions that when executed by a system cause the system to:
parse recorded event data into a plurality of segments, said recorded event data comprising video data and sensor data mapped to video frames of said video data;
assign a significance value to each segment of said plurality of segments;
compare the significance value of each segment of said plurality of segments to a first significance threshold;
assign a first playback speed to each segment of said plurality of segments having a significance value exceeding said first significance threshold;
assign a second playback speed to each segment of said plurality of segments having a significance value below said first significance threshold, the second playback speed being greater than the first playback speed; and
generate a playback index to identify each of said plurality of segments with a corresponding playback speed.

44. The at least one computer-readable medium of claim 43, wherein the sensor data comprises data recorded by at least one of an accelerometer, an audio sensor, a gyrometer, a global positioning system, a pressure sensor, a light sensor, a humidity sensor, a biometric sensor, and an audio sensor.

45. The at least one computer-readable medium of claim 44, wherein said instructions when executed further cause the system to assign a significance value to each segment of said plurality of segments based at least in part on control parameters contained within a control profile, wherein said control parameters specify the assignment of significance values to each segment of said plurality of segments based at least in part on an analysis of said video data, said sensor data, or a combination thereof within a corresponding segment of said plurality of segments.

46. The at least one computer-readable medium of claim 45, wherein said control parameters specify a predetermined threshold, and said computer readable instructions when executed further cause the system to:
assign a first significance value to each segment of said plurality of segments;
monitor said sensor data as a function of time within each of said plurality of segments; and
increase or decrease the first significance value assigned to a segment when the value of sensor data vs. time or rate of change of the value of sensor data vs. time deviates from the value of sensor data value vs. time or rate of change of sensor data value vs. time in an immediately prior segment by said predetermined threshold.

47. The at least one computer readable medium of claim 45, wherein said control parameters specify the assignment of significance values based at least in part on the presence of biometric information in said recorded event data, wherein said instructions when executed further cause said system to assign said significance values by:
assigning a first significance value to each of said plurality of segments;
analyzing said video and sensor data within each of said plurality of segments for the presence of said biometric information;
increasing the first significance value assigned to a segment of said plurality of segments in which said biometric information is detected; and
decreasing the first significance value assigned to a segment of said plurality of segments in which said biometric information is not detected.

48. The at least one computer-readable medium of claim 45, wherein said instructions when executed further cause said system to:
identify adjacent first and second segments of said plurality of segments, wherein said first segment is assigned said second playback speed and said second segment is assigned said first playback speed;
classify portions of said recorded event data encompassing at least a portion of said first and second segments as a first transition segment; and
assign a third playback speed to each first transition segment, wherein said third playback speed is a variable playback speed.

49. The at least one computer-readable medium of claim 48, wherein said instructions when executed further cause said system to:
identify adjacent third and fourth segments of said plurality of segments, wherein said third segment is assigned said first playback speed and said fourth segment is assigned said second playback speed;
classify portions of said recorded event data encompassing at least a portion of said third and fourth segments as a second transition segment; and
assign a fourth playback speed to each second transition segment, wherein said fourth playback speed is a variable playback speed.

50. The at least one computer-readable medium of claim 44, wherein said instructions when executed further cause said system to:
compare the significance value of each of said plurality of segments to a second significance threshold and a third significance threshold, the second and third significance thresholds being greater than and less than said first significance threshold, respectively;
assign a fifth playback speed to each segment of said plurality of segments having a significance value exceeding said second significance threshold, the fifth playback speed being less than said first playback speed; and
assign a sixth playback speed to each segment of said plurality of segments having a significance value below said third significance threshold, the sixth playback speed being greater than said first playback speed.
